(19) United States
(12) Patent Application Publication
(10) Pub. No.: US 2020/0356153 A1
(43) Pub. Date: Nov. 12, 2020

(54) STORAGE DEVICE AND OPERATING METHOD OF THE STORAGE DEVICE

(71) Applicant: SK hynix Inc., Icheon-si Gyeonggi-do (KR)

(72) Inventor: Jae Heung KIM, Hwaseong-si Gyeonggi-do (KR)

(73) Assignee: SK hynix Inc., Icheon-si Gyeonggi-do (KR)

(21) Appl. No.: 16/726,746

(22) Filed: Dec. 24, 2019

(30) Foreign Application Priority Data
May 10, 2019 (KR) 10-2019-0055120

(51) Int. Cl. G06F 1/28; G06F 3/06

(52) U.S. Cl. CPC G06F 1/28; G06F 3/0673; G06F 3/0653; G06F 3/0625

(57) ABSTRACT

A storage device includes: a memory device group including a plurality of memory devices; a memory controller for generating power characteristic information on power consumed by the memory device group, based on a physical device characteristic of each of the plurality of memory devices; and a power management device for controlling power supplied to the memory device group, based on the power characteristic information and power mode information. The power mode information refers to power consumption determined according to an operating environment of the memory device group.

### CROSS-REFERENCE TO RELATED APPLICATION

The present application claims priority under 35 U.S.C. § 119(a) to Korean patent application number 10-2019-0055120, filed on May 10, 2019, the entire disclosure of which is incorporated herein by reference in its entirety.

### BACKGROUND

### 1. Technical Field

The present disclosure generally relates to an electronic device, and more particularly, to a storage device and an operating method of the storage device.

### 2. Related Art

A storage device is a device that stores data under the control of a host device such as a computer or a smart phone. The storage device may include a memory device for storing data and a memory controller for controlling the memory device. The memory device is classified into a volatile memory device and a nonvolatile memory device.

The volatile memory device is a memory device in which data is stored only when power is supplied, and stored data is lost when the supply of power is interrupted. The volatile memory device may include a Static Random Access Memory (SRAM), a Dynamic Random Access Memory (DRAM), and the like.

The nonvolatile memory device is a memory device in which data is not lost even when the supply of power is interrupted. The nonvolatile memory device may include a Read Only Memory (ROM), a Programmable ROM (PROM), an Electrically Programmable ROM (EPROM), an Electrically Erasable ROM (EEROM), a flash memory, and the like.

### SUMMARY

In accordance with an aspect of the present disclosure, there is provided a storage device which may include: a memory device group including a plurality of memory devices; a memory controller configured to generate power characteristic information on power consumed by the memory device group, based on a physical device characteristic of each of the plurality of memory devices; and a power management device configured to control power supplied to the memory device group, based on the power characteristic information and power mode information, wherein the power mode information refers to power consumption determined according to an operating environment of the memory device group.

In accordance with another aspect of the present disclosure, there is provided a storage device which may include: a memory device group including a plurality of memory devices; a memory controller configured to generate power characteristic information on power consumed by the memory device group, based on a physical device characteristic of each of the plurality of memory devices, and generate power mode information on power consumed by the memory device group, based on an operating environment of the memory device group; and a power management device configured to control power supplied to the memory device group, based on the power characteristic information and the power mode information.

In accordance with another aspect of the present disclosure, there is provided a method for operating a storage device, the method which may include: generating power characteristic information on power consumed by a memory device group including a plurality of memory devices, based on a physical device characteristic of each of the plurality of memory devices; setting a base level of power supplied to the memory device group, based on the power characteristic information; and controlling the supplied power, based on power mode information on power consumption, which is determined based on an operating environment of the memory device group.

### BRIEF DESCRIPTION OF THE DRAWINGS

Examples of embodiments will now be described hereinafter with reference to the accompanying drawings

FIG. 1 is a diagram illustrating a storage device in accordance with an embodiment of the present disclosure.

FIG. 2 is a diagram illustrating a structure of a memory device shown in FIG. 1.

FIG. 3 is a diagram illustrating an embodiment of a memory cell array shown in FIG. 2.

FIG. 4 is a circuit diagram illustrating any one memory block among memory blocks shown in FIG. 3.

FIG. 5 is a circuit diagram illustrating another embodiment of the one memory block among the memory blocks shown in FIG. 3.

FIG. 6 is a diagram illustrating an operation of a memory controller for controlling a plurality of memory devices.

FIG. 7 is a diagram illustrating a configuration and an operation of the storage device in accordance with an embodiment of the present disclosure.

FIG. 8 is a diagram illustrating a configuration and an operation of a memory controller shown in FIG. 7.

FIG. 9 is a diagram illustrating a configuration and an operation of the storage device in accordance with another embodiment of the present disclosure.

FIG. 10 is a diagram illustrating a configuration and an operation of a memory controller shown in FIG. 9.

FIG. 11 is a diagram illustrating power weight setting tables shown in FIGS. 8 and 10.

FIG. 12 is a diagram illustrating device characteristic information in accordance with an embodiment of the present disclosure.

FIG. 13 is a diagram illustrating a power characteristic information generating operation in accordance with an embodiment of the present disclosure.

FIG. 14 is a diagram illustrating power control information shown in FIGS. 8 and 10.

FIG. 15 is a flowchart illustrating an operation of the storage device in accordance with an embodiment of the present disclosure.

FIG. 16 is a flowchart illustrating an operation of the storage device in accordance with an embodiment of the present disclosure.

FIG. 17 is a diagram illustrating a configuration and an operation of the storage device in accordance with another embodiment of the present disclosure.

FIG. 18 is a diagram illustrating an operation of determining priority orders of memory devices shown in FIG. 17.

FIG. 19 is a flowchart illustrating an operation of a memory controller shown in FIG. 17.

FIG. 20 is a diagram illustrating another embodiment of the memory controller shown in FIG. 1.

FIG. 21 is a block diagram illustrating a memory card system to which the storage device is applied in accordance with an embodiment of the present disclosure.

FIG. 22 is a block diagram exemplarily illustrating a Solid State Drive (SSD) system to which the storage device is applied in accordance with an embodiment of the present disclosure.

FIG. 23 is a block diagram illustrating a user system to which the storage device is applied in accordance with an embodiment of the present disclosure.

### DETAILED DESCRIPTION

Embodiments may provide a storage device having efficient power supply capability and an operating method of the storage device.

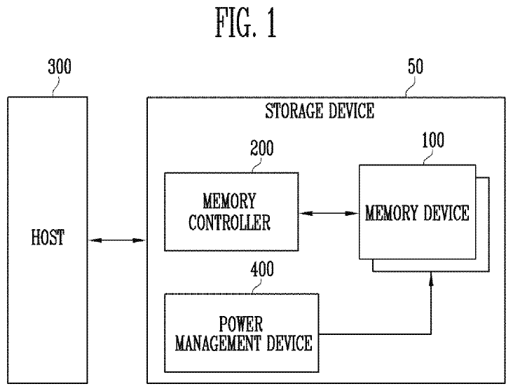

FIG. 1 is a diagram illustrating a storage device in accordance with an embodiment of the present disclosure.

Referring to FIG. 1, the storage device may include a memory device 100, a memory controller 200 configured to control an operation of the memory device 100, and a power management device 400. The storage device 50 may be a device for storing data under the control of a host 300, such as a mobile phone, a smart phone, an MP3 player, a laptop computer, a desktop computer, a game console, a TV, a tablet PC or an in-vehicle infotainment.

The storage device 50 may be manufactured as any one of various types of storage devices according to a host interface that is a communication scheme with the host 300. For example, the storage device 50 may be implemented with any one of a variety of types of storage devices, such as a Solid State Drive (SSD), a Multi-Media Card (MMC), an Embedded MMC (eMMC), a Reduced Size MMC (RS-MMC), a micro-MMC (micro-MMC), a Secure Digital (SD) card, a mini-SD card, a micro-SD card, a Universal Serial Bus (USB) storage device, a Universal Flash Storage (UFS) device, a Compact Flash (CF) card, a Smart Media Card (SMC), a memory stick, and the like.

The storage device 50 may be manufactured as any one of various kinds of package types. For example, the storage device 50 may be manufactured as any one of various kinds of package types such as a Package-On-Package (POP), a System-In-Package (SIP), a System-On-Chip (SOC), a Multi-Chip Package (MCP), a Chip-On-Board (COB), a Wafer-level Fabricated Package (WFP), and a Wafer-level Stack Package (WSP).

The memory device 100 may store data. The memory device 100 operates under the control of the memory controller 200. The memory device 100 may include a memory cell array including a plurality of memory cells for storing data.

Each of the memory cells may be configured as a Single Level Cell (SLC) for storing one data bit, a Multi-Level Cell (MLC) for storing two data bits, a Triple Level Cell (TLC) for storing three data bits, or a Quad Level Cell (QLC) for storing four data bits.

The memory cell array may include a plurality of memory blocks. Each memory block may include a plurality of memory cells. One memory block may include a plurality of pages. In an embodiment, the page may be a unit for storing data in the memory device 100 or reading data stored in the memory device 100. The memory block may be a unit for erasing data.

In an embodiment, the memory device 100 may be a Double Data Rate Synchronous Dynamic Random Access Memory (DDR SDRAM), a Low Power Double Data Rate 4 (LPDDR4) SDRAM, a Graphics Double Data Rate (GDDR) SRAM, a Low Power DDR (LPDDR), a Rambus Dynamic Random Access Memory (RDRAM), a NAND flash memory, a vertical NAND flash memory, a NOR flash memory, a Resistive Random Access Memory (RRAM), a Phase-Change Random Access Memory (PRAM), a Magnetoresistive Random Access Memory (MRAM), a Ferroelectric Random Access Memory (FRAM), a Spin Transfer Torque Random Access Memory (STT-RAM), or the like. In this specification, for convenience of description, a case where the memory device 100 is a NAND flash memory is assumed and described.

The memory device 100 receives a command and an address from the memory controller 200 and accesses an area selected by the address in the memory cell array. That is, the memory device 100 may perform an operation corresponding to the command on the area selected by the address. For example, the memory device 100 may perform a write (program) operation, a read operation, and an erase operation. In the program operation, the memory device 100 may program data in the area selected by the address. In the read operation, the memory device 100 may read data from the area selected by the address. In the erase operation, the memory device 100 may erase data stored in the area selected by the address.

In an embodiment, the memory device 100 may provide device characteristic information to the memory controller 200 in response to a device characteristic command. The device characteristic information may include information on an operation speed characteristic of the memory device 100, which is determined according to a timing skew of the memory device 100. The timing skew may be a value representing a degree to which an operation clock of the memory device 100 is delayed with respect to a reference clock.

The operation speed characteristic may be divided into a fast type, a typical type, and a slow type according to a comparison result of the timing skew of the memory device 100 and a reference value. In various embodiments, the operation speed characteristic may be divided into a larger number of types.

The memory device 100 may measure a timing skew of itself by using various methods. For example, the memory device 100 may measure a timing skew of itself by using ZQ calibration or Ring Oscillator Delay (ROD).

The memory controller 200 may control overall operations of the storage device 50.

When power is applied to the storage device 50, the memory controller 200 may execute firmware (FW). When the memory device 100 is a flash memory device, the memory controller 200 may execute FW such as a Flash Translation Layer (FTL) for controlling communication between the host 300 and the memory device 100.

In an embodiment, the memory controller 200 may receive data and a Logical Block Address (LBA) from the host 300, and translate the LBA into a Physical Block Address (PBA) representing addresses of memory cells included in the memory device 100, in which data is to be stored.

The memory controller 200 may control the memory device 100 to perform a program operation, a read operation, an erase operation, or the like in response to a request from the host 300. In the program operation, the memory controller 200 may provide a program command, a PBA, and data to the memory device 100. In the read operation, the memory controller 200 may provide a read command and a PBA to the memory device 100. In the erase operation, the memory controller 200 may provide an erase command and a PBA to the memory device 100.

In an embodiment, the memory controller 200 may autonomously generate a program command, an address, and data regardless of a request from the host 300, and transmit the program command, the address, and the data to the memory device 100. For example, the memory controller 200 may provide the command, the address, and the data to the memory device 100 to perform background operations such as a program operation for wear leveling and a program operation for garbage collection.

In an embodiment, the memory controller 200 may control at least two memory devices 100. The memory controller 200 may control the memory devices according to an interleaving scheme so as to improve operational performance. The interleaving scheme may be an operating scheme that allows operating sections of at least two memory devices 100 to overlap with each other.

In an embodiment, the memory controller 200 may generate power characteristic information. The power characteristic information may be information on a power level to be supplied to one memory device group. The one memory device group may include a plurality of memory device 100 commonly coupled to the memory controller 200 through one channel.

For example, the memory controller 200 may generate power characteristic information by using device characteristic information respectively corresponding to the plurality of memory devices 100 included in the one memory device group. The device characteristic information may include information on the operation speed characteristic of the memory device 100.

A power weight code may be determined based on the operation speed characteristic of the memory device 100. For example, when the operation speed characteristic of the memory device 100 is the typical type, the supply of power having a reference level may be required to maintain an operation speed. Therefore, the power weight code may have a value of 0. When the operation speed characteristic of the memory device 100 is the slow type, the supply of power having a level higher than the reference level may be required to increase the operation speed. Therefore, the power weight code may have a positive value. When the operation speed characteristic of the memory device 100 is the fast type, the supply of power having a level lower than the reference level may be required to decrease the operation speed. Therefore, the power weight code may have a negative value.

In other words, when the operation speed characteristic of the memory device 100 is the typical type, the supply of power having the reference level to the memory device 100 may be required to perform a normal operation of the memory device 100. Therefore, the power weight code may have the value of 0. When the operation speed characteristic of the memory device 100 is the slow type, the supply of power having a level higher than the reference level to the memory device 100 may be required to perform the normal operation of the memory device 100. Therefore, the power weight code may have a positive value. When the operation speed characteristic of the memory device 100 is the fast type, the memory device may perform the normal operation even when power of a level lower than the reference level is supplied to the memory device 100. Therefore, the power weight code may have a negative value.

The memory controller 200 may calculate a final power weight code by synthesizing power weight codes of the respective memory devices 100 included in the one memory device group. The memory controller 200 may determine a power level to be supplied to the one memory device group according to the final power weight code. The memory controller 200 may generate power characteristic information representing the power level determined according to the final power weight code. In other words, the power characteristic information may be information on power consumed by the memory device group, based on a physical device characteristic of each of the plurality of memory devices. The physical device characteristic indicates whether a memory device is good or bad under various physical factors such as power consumption, operation speed, heat generation and stability, and so on. The memory controller 200 may generate power characteristic information corresponding to each of a plurality of memory device groups coupled through a plurality of channels.

In an embodiment, the memory controller 200 may provide the generate power characteristic information to the host 300.

In another embodiment, the memory controller 200 may provide the generated power characteristic information to the power management device 400. The memory controller 200 may generate power mode information. The memory controller 200 may provide the generated power mode information to the power management device 400.

The power mode information may be information on a power mode determined based on operations that each of the plurality of memory devices 100 included in the memory device group is performing or is to perform. The power mode may be divided into a low power mode, a basic power mode, and a high power mode. In various embodiments, the power mode may be divided into a larger number of modes according to a degree to which power is consumed.

For example, the memory controller 200 may generate power mode information, based on an operation of the memory device 100, which is performed in response to a request from the host 300, or an internal operation of the memory device 100, which is performed regardless of the request from the host 300.

The memory controller 200 may generate power mode information corresponding to the memory device group by considering an operation of each of the plurality of memory device 100 included in the memory device group. When the power mode information is generated, the memory controller 200 may consider overall conditions of an operation performed by each memory device 100, such as a number of the memory devices included in the memory device group, a kind of the operation performed by each memory device 100, a time for which the operation is performed, and an operating frequency. The operation of each memory device 100 may be performed in response to a request from the host 300, or be an internal operation of the memory device 100, which is performed regardless of the request from the host 300, such as a background operation.

The host 300 may communicate with the storage device 50, using at least one of various communication manners, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a Non-Volatile Memory express (NVMe), a universal flash storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

In an embodiment, the host 300 may receive power characteristic information corresponding to each memory device group from the memory controller 200.

In an embodiment, the host 300 may generate power mode information. The power mode information may be information on a power mode determined based on operations that each of a plurality of memory devices 100 included in one memory device group is performing or is to perform in response to a request from the host 300. In other words, the power mode information may be information on power consumed by the memory device group, based on an operating environment of the memory device group. When the power mode information is generated, the host 300 may consider overall conditions of an operation performed by each memory device 100, such as a number of the memory devices included in the memory device group, a kind of the operation performed by each memory device 100, a time for which the operation is performed, and an operating frequency.

In an embodiment, the host 300 may provide the power management device 400 with power control information including power characteristic information and power mode information.

The power management device 400 may include a plurality of power modules. Each power module may supply power to a corresponding memory device group.

In an embodiment, the power management device 400 may receive power control information from the host 300. In another embodiment, the power management device 400 may receive power control information from the memory controller 200.

The power management device may control power supplied to a memory device group corresponding to each power module, based on the power control information. The power management device 400 may set a base level of the power that the power module supplies to the memory device group, based on power characteristic information included in the power control information. When the storage device 50 is booted up, the power management device 400 may perform a setup operation of setting a base level of power supplied by each power module. The set base level of the power has a static value until before the storage device 50 is re-booted up.

The power management device 400 may control power supplied by each power module, based on power mode information included in the power control mode. That is, the power management device 400 may flexibly control the power supplied by the power module, based on the power mode information, in a state in which the base level of the power supplied by the power module is set according to the setup operation. In other words, the power management device 400 may control an operation level of power according to the power mode information. The operation level of the power may be a level of power supplied by a power module according to a power mode represented by the power mode information. The power mode represented by the power mode information may be dynamically modified as an operation state of memory devices included in a memory device group is changed.

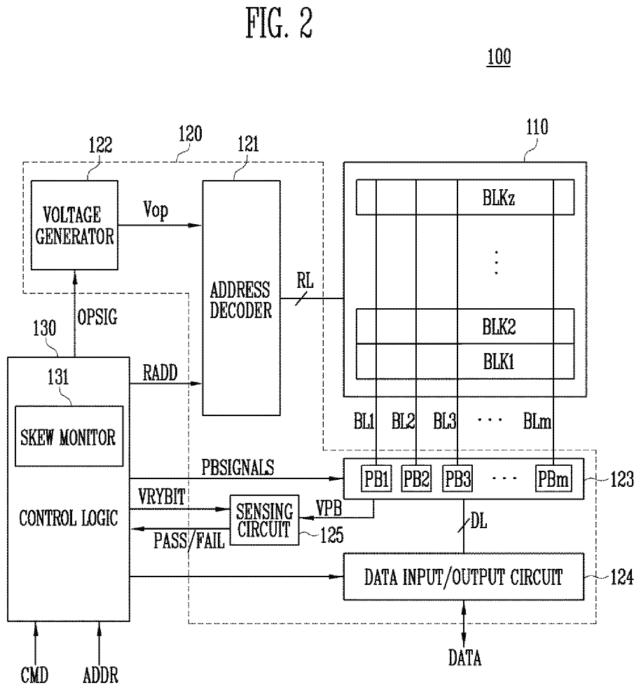

FIG. 2 is a diagram illustrating a structure of the memory device shown in FIG. 1.

Referring to FIG. 2, the memory device 100 may include a memory cell array 110, a peripheral circuit 120, and -control logic 130.

The memory cell array 110 includes a plurality of memory blocks BLK1 to BLKz. The plurality of memory blocks BLK1 to BLKz are coupled to an address decoder 121 through row lines RL. The plurality of memory blocks BLK1 to BLKz are coupled to a read/write circuit 123 through bit lines BL1 to BLm. Each of the plurality of memory blocks BLK1 to BLKz includes a plurality of memory cells.

In an embodiment, the plurality of memory cells may be nonvolatile memory cells. Memory cells coupled to the same word line among the plurality of memory cells may be defined as one physical page. That is, the memory cell array 110 may be configured with a plurality of physical pages. In accordance with an embodiment of the present disclosure, each of the plurality of memory blocks BLK1 to BLKz included in the memory cell array 110 may include a plurality of dummy cells. One or more dummy cells may be coupled in series between a drain select transistor and memory cells and between a source select transistor and the memory cells.

Each of the memory cells of the memory device may be configured as a Single Level Cell (SLC) for storing one data bit, a Multi-Level Cell (MLC) for storing two data bits, a Triple Level Cell (TLC) for storing three data bits, or a Quad Level Cell (QLC) for storing four data bits.

The peripheral circuit 120 may include the address decoder 121, a voltage generator 122, the read/write circuit 123, a data input/output circuit 124, and a sensing circuit 125.

The peripheral circuit 120 drives the memory cell array 110. For example, the peripheral circuit 120 may drive the memory cell array 110 to perform a program operation, a read operation, and an erase operation.

The address decoder 121 is coupled to the memory cell array 110 through the row lines RL. The row lines RL may include drain select lines, word lines, source select lines, and a common source line. In accordance with an embodiment of the present disclosure, the word lines may include normal word lines and dummy word lines. In accordance with an embodiment of the present disclosure, the row lines RL may further include a pipe select line.

In an embodiment, the row lines RL may be local lines included in local line groups. The local line group may correspond to one memory block. The local line group may include a drain select line, local word lines, and a source select line.

The address decoder 121 may operate under the control of the control logic 130. The address decoder 121 receives an address ADDR from the control logic 130.

The address decoder 121 may decode a block address in the received address ADDR. The address decoder 121 selects at least one memory block among the memory blocks BLK1 to BLKz according to the decoded block address. The address decoder 121 may decode a row address RADD in the received address ADDR. The address decoder 121 may select at least one word line of the selected memory block by applying voltages provided from the voltage generator 122 to the word line WL according to the decoded row address RADD.

In a program operation, the address decoder 121 may apply a program voltage to the selected word line, and apply a pass voltage having a level lower than that of the program voltage to unselected word lines. In a program verify operation, the address decoder 121 may apply a verify voltage to the selected word line, and apply a verify pass voltage having a level higher than that of the verify voltage to the unselected word lines.

In a read operation, the address decoder 121 may apply a read voltage to the selected word line, and apply a read pass voltage having a level higher than that of the read voltage to the unselected word lines.

In accordance with an embodiment of the present disclosure, an erase operation of the memory device 100 is performed in units of memory blocks. In an erase operation, the address ADDR input to the memory device 100 includes a block address. The address decoder 121 may decode the block address and select one memory block according to the decoded block address. In the erase operation, the address decoder 121 may apply a ground voltage to word lines coupled to the selected memory block.

In accordance with an embodiment of the present disclosure, the address decoder 121 may decode a column address in the address ADDR transmitted thereto. The decoded column address may be transmitted to the read/write circuit 123. In an example, the address decoder 121 may include components such as a row decoder, a column decoder, and an address buffer.

The voltage generator 122 may generate a plurality of operating voltages Vop by using an external power voltage supplied to the memory device 100. The voltage generator 122 operates under the control of the control logic 130.

In an embodiment, the voltage generator 122 may generate an internal power voltage by regulating the external power voltage. The internal power voltage generated by the voltage generator 122 is used as an operation voltage of the memory device 100.

In an embodiment, the voltage generator 122 may generate a plurality of operating voltages Vop by using the external power voltage or the internal power voltage. The voltage generator 122 may generate various voltages required by the memory device 100. For example, the voltage generator 122 may generate a plurality of erase voltages, a plurality of program voltages, a plurality of pass voltages, a plurality of select read voltages, and a plurality of unselect read voltages.

In order to generate a plurality of operating voltages Vop having various voltage levels, the voltage generator 122 may include a plurality of pumping capacitors for receiving the internal power voltage, and generate the plurality of operating voltages Vop by selectively activating the plurality of pumping capacitors under the control of the control logic 130.

The plurality of generated voltages Vop may be supplied to the memory cell array 110 by the address decoder 121.

The read/write circuit 123 includes first to mth page buffers PB1 to PBm. The first to mth page buffers PB1 to PBm are coupled to the memory cell array 110 through the respective first to mth bit lines BL1 to BLm. The first to mth page buffers PB1 to PBm operate under the control of the control logic 130.

The first to mth page buffers PB1 to PBm communicate data DATA with the data input/output circuit 124. In a program operation, the first to mth page buffers PB1 to PBm receive data DATA to be stored through the data input/output circuit 124 and data lines DL.

In a program operation, the first to mth page buffers PB1 to PBm may transfer, to selected memory cells through the bit lines BL1 to BLm, data DATA received through the data input/output circuit 124 when a program pulse is applied to a selected word line. The memory cells of the selected memory cells are programmed according to the transferred data DATA. A memory cell coupled to a bit line through which a program allow voltage (e.g., a ground voltage) is applied may have an increased threshold voltage. A threshold voltage of a memory cell coupled to a bit line through which a program inhibit voltage (e.g., a power voltage) is applied may be maintained. In a program verify operation, the first to mth page buffers PB1 to PBm read data DATA stored in the selected memory cells from the selected memory cells through the bit lines BL1 to BLm.

In a read operation, the read/write circuit 123 may read data DATA from memory cells of a selected page through the bit lines BL, and store the read data DATA in the first to mth page buffers PB1 to PBm.

In an erase operation, the read/write circuit 123 may float the bit lines BL. In an embodiment, the read/write circuit 123 may include a column select circuit.

The data input/output circuit 124 is coupled to the first to mth page buffers PB1 to PBm through the data lines DL. The data input/output circuit 124 operates under the control of the control logic 130.

The data input/output circuit 124 may include a plurality of input/output buffers (not shown) that receive input data DATA. In a program operation, the data input/output circuit 124 may receive data DATA to be stored from an external controller (not shown). In a read operation, the data input/output circuit 124 outputs, to the external controller, data transmitted from the first to mth page buffers PB1 to PBm included in the read/write circuit 123.

In a read operation or verify operation, the sensing circuit 125 may generate a reference current in response to an allow bit VRYBIT signal generated by the control logic 130, and output a pass signal or fail signal to the control logic 130 by comparing a sensing voltage VPB received from the read/write circuit 123 and a reference voltage generated by the reference current.

The control logic 130 may be coupled to the address decoder 121, the voltage generator 122, the read/write circuit 123, the data input/output circuit 124, and the sensing circuit 125. The control logic 130 may control overall operations of the memory device 100. The control logic 130 may operate in response to a command CMD transferred from an external device.

The control logic 130 may control the peripheral circuit 120 by generating several signals in response to a command CMD and an address ADDR. For example, the control logic 130 may generate an operation signal OPSIG, a row address RADD, a read/write circuit control signal PBSIGNALS, and an allow bit VRYBIT in response to the command CMD and the address ADDR. The control logic 130 may output the operation signal OPSIG to the voltage generator 122, output the row address RADD to the address decoder 121, output the read/write circuit control signal PBSIGNALS to the read/write circuit 123, and output the allow bit VRYBIT to the sensing circuit 125. Also, the control logic 130 may determine whether the verify operation has passed or failed in response to the pass or fail signal PASS/FAIL output by the sensing circuit 125. The control logic 130 may be implemented as hardware, software, or a combination of hardware and software. For example, the control logic 130 may be a control logic circuit operating in accordance with an algorithm and/or a processor executing control logic code.

In an embodiment, the control logic 130 may include a skew monitor 131.

In an embodiment, the skew monitor 131 may generate device characteristic information in response to a device characteristic command provided by the memory controller 200, and provide the generated device characteristic information to the memory controller 200. The device characteristic information may include information on an operation speed characteristic of the memory device 100, which is determined according to a timing skew.

For example, the skew monitor 131 may measure a timing skew of the memory device 100 by using various methods. The timing skew may be a value representing a degree to which an operation clock of the memory device 100 is delayed with respect to a reference clock. The skew monitor 131 may measure a timing skew of the memory device 100 by using ZQ calibration or Ring Oscillator Delay (ROD).

The skew monitor 131 may determine an operation speed characteristic of the memory device 100, based on a comparison result of the timing skew of the memory device 100 and a reference value. The operation speed characteristic of the memory device 100 may be divided into a fast type, a typical type, and a slow type. In various embodiments, the operation speed characteristic of the memory device 100 may be divided into a larger number of types.

The skew monitor 131 may generate device characteristic information representing the determined operation speed characteristic of the memory device 100.

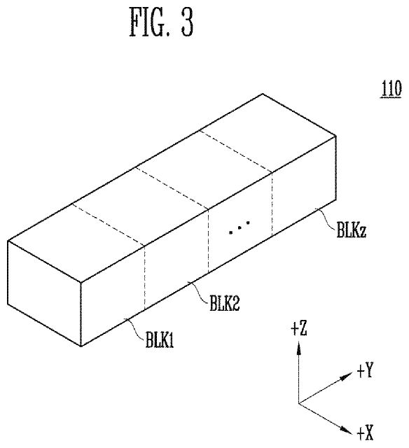

FIG. 3 is a diagram illustrating an embodiment of the memory cell array shown in FIG. 2.

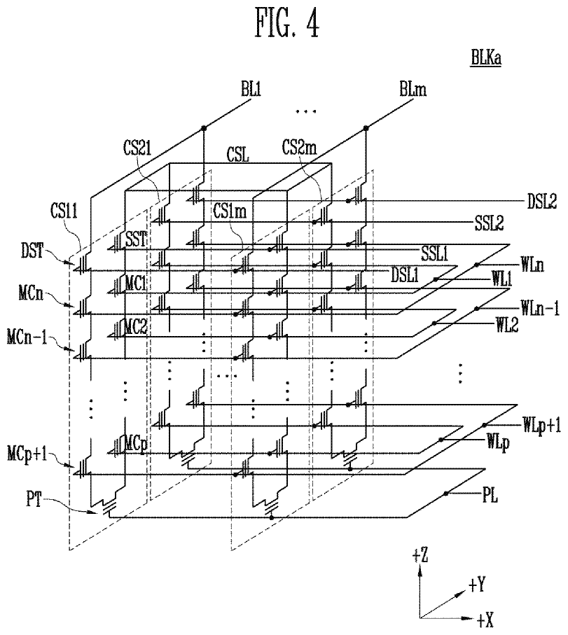

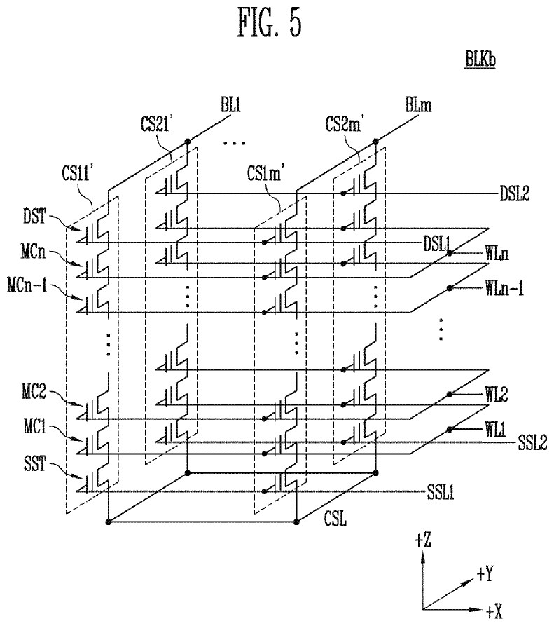

Referring to FIG. 3, the memory cell array 110 may include a plurality of memory blocks BLK1 to BLKz. Each memory block may have a three-dimensional structure. Each memory block may include a plurality of memory cells stacked on a substrate (not shown). The plurality of memory cells may be arranged along +X, +Y, and +Z directions. A structure of each memory block will be described in more detail with reference to FIGS. 4 and 5.

FIG. 4 is a circuit diagram illustrating any one memory block BLKa among the memory blocks BLK1 to BLKz shown in FIG. 3.

Referring to FIG. 4, the memory block BLKa may include a plurality of cell strings CS11 to CS1m and CS21 to CS2m. In an embodiment, each of the plurality of cell strings CS11 to CS1m and CS21 to CS2m may be formed in a ‘U’ shape. In the memory block BLKa, m cell strings are arranged in a row direction (i.e., a +X direction). FIG. 4 illustrates two cell strings arranged in a column direction (i.e., a +Y direction). However, this is for convenience of description, and it will be understood that three cell strings may be arranged in the column direction.

Each of the plurality of cell strings CS11 to CS1m and CS21 to CS2m may include at least one source select transistor SST, first to nth memory cells MC1 to MCn, a pipe transistor PT, and at least one drain select transistor DST.

The select transistors SST and DST and the memory cells MC1 to MCn may have structures similar to one another. In an embodiment, each of the select transistors SST and DST and the memory cells MC1 to MCn may include a channel layer, a tunneling insulating layer, a charge storage layer, and a blocking insulating layer. In an embodiment, a pillar for providing the channel layer may be provided in each cell string. In an embodiment, a pillar for providing at least one of the channel layer, the tunneling insulating layer, the charge storage layer, and the blocking insulating layer may be provided in each cell string.

The source select transistor SST of each cell string is coupled between a common source line CSL and memory cells MC1 to MCp.

In an embodiment, the source select transistors of cell strings arranged on the same row are coupled to a source select line extending in the row direction, and the source select transistors of cell strings arranged on different rows are coupled to different source select lines. In FIG. 4, the source select transistors of the cell strings CS11 to CS1m on a first row are coupled to a first source select line SSL1. The source select transistors of the cell strings CS21 to CS2m on a second row are coupled to a second source select line SSL2.

In another embodiment, the source select transistors of the cell strings CS11 to CS1m and CS21 to CS2m may be commonly coupled to one source select line.

The first to nth memory cells MC1 to MCn of each cell string are coupled between the source select transistor SST and the drain select transistor DST.

The first to nth memory cells MC1 to MCn may be divided into first to pth memory cells MC1 to MCp and a (p+1)th to nth memory cells MCp+1 to MCn. The first to pth memory cells MC1 to MCp are sequentially arranged in the opposite direction of a +Z direction, and are coupled in series between the source select transistor SST and the pipe transistor PT. The (p+1)th to nth memory cells MCp+1 to MCn are sequentially arranged in the +Z direction, and are coupled in series between the pipe transistor PT and the drain select transistor DST. The first to pth memory cells MC1 to MCp and the (p+1)th to nth memory cells MCp+1 to MCn are coupled through the pipe transistor PT. Gate electrodes of the first to nth memory cells MC1 to MCn of each cell string are coupled to first to nth word lines WL1 to WLn, respectively.

A gate of the pipe transistor PT of each cell string is coupled to a pipe line PL.

The drain select transistor DST of each cell string is coupled between a corresponding bit line and the memory cells MCp+1 to MCn. Cell strings arranged in the row direction are coupled to a drain select line extending in the row direction. The drain select transistors of the cell strings CS11 to CS1m on the first row are coupled to a first drain select line DSL1. The drain select transistors of the cell strings CS21 to CS2m on the second row are coupled to a second drain select line DSL2.

Cell strings arranged in the column direction are coupled to a bit line extending in the column direction. In FIG. 4, the cell strings CS11 and CS21 on a first column are coupled to a first bit line BL1. The cell strings CS1m and CS2m on an mth column are coupled to an mth bit line BLm.

Memory cells coupled to the same word line in the cell strings arranged in the row direction constitute one page. For example, memory cells coupled to the first word line WL1 in the cell strings CS11 to CS1m on the first row constitute one page. Memory cells coupled to the first word line WL1 in the cell strings CS21 to CS2m on the second row constitute another page. As any one of the drain select lines DSL1 and DSL2 is selected, cell strings arranged in one row direction may be selected. As any one of the word lines WL1 to WLn is selected, one page may be selected in the selected cell strings.

In another embodiment, even bit lines and odd bit lines may be provided instead of the first to mth bit lines BL1 to BLm. In addition, even-numbered cell strings among the cell strings CS11 to CS1m or CS21 to CS2m arranged in the row direction may be coupled to the even bit lines, respectively, and odd-numbered cell strings among the cell strings CS11 to CS1m or CS21 to CS2m arranged in the row direction may be coupled to the odd bit lines, respectively.

In an embodiment, at least one of the first to nth memory cells MC1 to MCn may be used as a dummy memory cell. For example, the at least one dummy memory cell may be provided to decrease an electric field between the source select transistor SST and the memory cells MC1 to MCp. Alternatively, the at least one dummy memory cell may be provided to decrease an electric field between the drain select transistor DST and the memory cells MCp+1 to MCn. When the number of dummy memory cells increases, the reliability of an operation of the memory block BLKa is improved. On the other hand, the size of the memory block BLKa increases. When the number of dummy memory cells decreases, the size of the memory block BLKa decreases. On the other hand, the reliability of an operation of the memory block BLKa may be deteriorated.

In order to efficiently control the at least one dummy memory cell, the dummy memory cells may have a required threshold voltage. Before or after an erase operation of the memory block BLKa, a program operation may be performed on all or some of the dummy memory cells. When an erase operation is performed after the program operation is performed, the threshold voltage of the dummy memory cells control a voltage applied to the dummy word lines coupled to the respective dummy memory cells, so that the dummy memory cells can have the required threshold voltage.

FIG. 5 is a circuit diagram illustrating another embodiment BLKb of the one memory block among the memory blocks BLK1 to BLKz shown in FIG. 3.

Referring to FIG. 5, the memory block BLKb may include a plurality of cell strings CS11′ to CS1m′ and CS21′ to CS2m′. Each of the plurality of cell strings CS11′ to CS1m′ and CS21′ to CS2m′ extends along the +Z direction. Each of the plurality of cell strings CS11′ to CS1m′ and CS21′ to CS2m′ includes at least one source select transistor SST, first to nth memory cells MC1 to MCn, and at least one drain select transistor DST, which are stacked on a substrate (not shown) under the memory block BLKb.

The source select transistor SST of each cell string is coupled between a common source line CSL and the memory cells MC1 to MCn. The source select transistors of cell strings arranged on the same row are coupled to the same source select line. The source select transistors of the cell strings CS11′ to CS1m′ arranged on a first row are coupled to a first source select line SSL1. Source select transistors of the cell strings CS21′ to CS2m′ arranged on a second row are coupled to a second source select line SSL2. In another embodiment, the source select transistors of the cell strings CS11′ to CS1m′ and CS21′ to CS2m′ may be commonly coupled to one source select line.

The first to nth memory cells MC1 to MCn of each cell string are coupled in series between the source select transistor SST and the drain select transistor DST. Gate electrodes of the first to nth memory cells MC1 to MCn are coupled to first to nth word lines WL1 to WLn, respectively.

The drain select transistor DST of each cell string is coupled between a corresponding bit line and the memory cells MC1 to MCn. The drain select transistors of cell strings arranged in the row direction are coupled to a drain select line extending in the row direction. The drain select transistors of the cell strings CS11′ to CS1m′ on the first row are coupled to a first drain select line DSL1. The drain select transistors of the cell strings CS21′ to CS2m′ on the second row are coupled to a second drain select line DSL2.

Consequently, the memory block BLKb of FIG. 5 has a circuit similar to that of the memory block BLKa of FIG. 4, except that the pipe transistor PT is excluded from each cell string in FIG. 5.

In another embodiment, even bit lines and odd bit lines may be provided instead of the first to mth bit lines BL1 to BLm. In addition, even-numbered cell strings among the cell strings CS11′ to CS1m′ or CS21′ to CS2m′ arranged in the row direction may be coupled to the even bit lines, respectively, and odd-numbered cell strings among the cell strings CS11′ to CS1m′ or CS21′ to CS2m′ arranged in the row direction may be coupled to the odd bit lines, respectively.

In an embodiment, at least one of the first to nth memory cells MC1 to MCn may be used as a dummy memory cell. For example, the at least one dummy memory cell may be provided to decrease an electric field between the source select transistor SST and the memory cells MC1 to MCp. Alternatively, the at least one dummy memory cell may be provided to decrease an electric field between the drain select transistor DST and the memory cells MCp+1 to MCn. When the number of dummy memory cells increases, the reliability of an operation of the memory block BLKb is improved. On the other hand, the size of the memory block BLKb is increased. When the number of dummy memory cells decreases, the size of the memory block BLKb decreases. On the other hand, the reliability of an operation of the memory block BLKb may be deteriorated.

In order to efficiently control the at least one dummy memory cell, the dummy memory cells may have a required threshold voltage. Before or after an erase operation of the memory block BLKb, a program operation may be performed on all or some of the dummy memory cells. When an erase operation is performed after the program operation is performed, the threshold voltage of the dummy memory cells control a voltage applied to the dummy word lines coupled to the respective dummy memory cells, so that the dummy memory cells can have the required threshold voltage.

FIG. 6 is a diagram illustrating an operation of the memory controller for controlling a plurality of memory devices.

Referring to FIG. 6, the memory controller 200 may be coupled to a plurality of memory devices Die_11 to Die_24 through a first channel CH1 and a second channel CH2. The number of channels or the number of memory devices coupled to each channel are not limited to these embodiments.

Memory devices Die_11 to Die_14 may be commonly coupled to the first channel CH1. The memory devices Die_11 to Die_14 may communicate with the memory controller 200 through the first channel CH1.

Since the memory devices Die_11 to Die_14 are commonly coupled to the first channel CH1, only one memory device may communicate with the memory device 200 at a time. However, operations internally performed by the respective memory devices Die_11 to Die_14 may be simultaneously performed.

Memory devices Die_21 to Die_24 may be commonly coupled to the second channel CH2. The memory devices Die_21 to Die_24 may communicate with the memory controller 200 through the second channel CH2.

Since the memory devices Die_21 to Die_24 are commonly coupled to the second channel CH2, only one memory device may communicate with the memory device 200 at a time. However, operations internally performed by the respective memory devices Die_21 to Die_24 may be simultaneously performed.

The storage device using a plurality of memory devices can improve performance by using data interleaving that is data communication using the interleaving scheme. The data interleaving may be data communication in which, in a structure in which two or more ways share one channel, a data read or write operation is performed while moving between the ways. In order to achieve the data interleaving, the memory devices may be managed in units of channels and ways. In order to maximize parallelization of memory devices coupled to each channel, the memory controller 200 may distribute and allocate a continuous logical memory area to the channels and the ways.

For example, the memory controller 200 may transmit a control signal including a command and an address and data to the memory device Die_11 through the first channel CH1. While the memory device Die_11 is programming the transmitted data in a memory cell included therein, the memory controller 200 may transmit a control signal including a command and an address and data to the memory device Die_12.

In FIG. 6, the plurality of memory devices may be configured into four ways WAY1 to WAY4. A first way WAY1 may include the memory devices Die_11 and Die_21. A second way WAY2 may include the memory devices Die_12 and Die_22. A third way WAY3 may include the memory devices Die_13 and Die_23. A fourth way WAY4 may include the memory devices Die_14 and Die_24.

Each of the channels CH1 and CH2 may be a bus of signals shared and used by memory devices coupled to the corresponding channel.

Although data interleaving in a 2-channel/4-way structure is described in FIG. 6, the efficiency of data interleaving may become more efficient as the number of channels and the number of ways become greater.

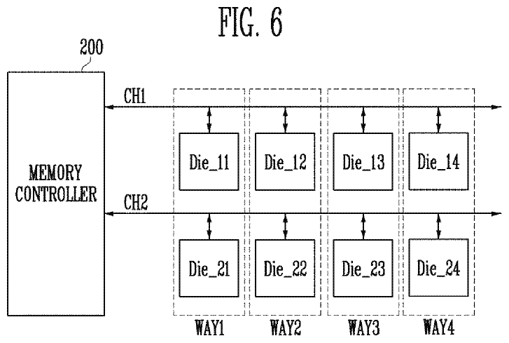

FIG. 7 is a diagram illustrating a configuration and an operation of the storage device in accordance with an embodiment of the present disclosure.

Referring to FIG. 7, the storage device 50 may include a plurality of memory devices Die_11 to Die_24, a memory controller 200, and a power management device 400.

A first memory device group may be a group of memory devices Die_11 to Die_14 commonly coupled to the memory controller 200 through a first channel CH1. A second memory device group may be a group of memory devices Die_21 to Die_24 commonly coupled to the memory controller 200 through a second channel CH2.

The memory controller 200 may include a power information manager 210A. The power information manager 210A may generate power characteristic information on each of the first and second memory device groups as described with reference to FIG. 1. Power characteristic information corresponding to the first memory device group may be information on a power level to be supplied to the first memory device group. Power characteristic information corresponding to the second memory device group may be information on a power level to be supplied to the second memory device group.

For example, the power information manager 210A may generate power characteristic information corresponding to the first memory device group by using device characteristic information respectively corresponding to the memory devices Die_11 to Die_14 included in the first memory device group. The power information manager 210A may provide a device state command to each of the memory devices Die_11 to Die_14 included in the first memory device group, and acquire device characteristic information of each of the memory devices Die_11 to Die_14 included in the first memory device group. The device characteristic information may include information on an operation speed characteristic of the memory device.

The power information manager 210A may calculate a final power weight code by synthesizing power weight codes of the respective memory device Die_11 to Die_14 included in the first memory device group. The power information manager 210A may determine a power level to be supplied to the first memory device group according to the final power weight code. The power information manager 210A may generate power characteristic information representing the power level to be supplied to the first memory device group, which is determined according to the final power weight code.

In the same manner, the power information manager 210A may generate power characteristic information corresponding to the second memory device group by using device characteristic information respectively corresponding to the memory devices Die_21 to Die_24 included in the second memory device group.

The power information manager 210A may provide the host 300 with the generated power characteristic information on each of the first and second memory device groups.

The host 300 may receive power characteristic information corresponding to the first and second memory device groups from the power information manager 210A.

The host 300 may generate power mode information corresponding to the first and second memory device groups.

The power mode information corresponding to the first memory device group may be information on a power mode determined based on operations that each of the memory devices Die_11 to Die_14 included in the first memory device group is performing or is to perform in response to a request from the host 300. The power mode information corresponding to the second memory device group may be information on a power mode determined based on operations that each of the memory devices Die_21 to Die_24 included in the second memory device group is performing or is to perform in response to a request from the host 300.

The host 300 may generate power control information. The host 300 may provide the generated power control information to a power module controller 410. The power control information may include power mode information generated by the host 300 and power characteristic information received from the power information manager 21A, which correspond to each of the first and second memory device groups.

The power management device 400 may include the power module controller 410 and a power module group 420.

The power module controller 410 may control power that each power module included in the power module group 420 supplies to a corresponding memory device group, based on the power control information.

The power module controller 410 may generate a base level of the power that each power module supplies to the corresponding memory device group, based on the power characteristic information included in the power control information. For example, the power module controller 410 may perform a setup operation of setting a base level of power supplied by each power module whenever a boot-up operation of the storage device 50 is performed.

The power module controller 410 may control the power supplied by each power module, based on the power mode information included in the power control mode. That is, the power module controller 410 may flexibly control the power supplied by the power module, based on the power mode information, in a state in which the base level of the power supplied by the power module is set according to the setup operation. In other words, the power module controller 410 may set a power operation level that the power module supplies, based on the power mode information. The power operation level may be a level of power consumed by a memory device group, which is flexibly changed depending on an operating environment of the memory device group.

For example, the power module controller 410 may set a base level of power supplied by a first power module in the boot-up operation of the storage device 50, based on the power characteristic information corresponding to the first memory device group. The power module controller 410 may flexibly control the power supplied by the first power module, based on the power mode information corresponding to the first memory device group. The power mode information may be information on power consumed by a memory device group, based on an operating environment of the memory device group.

In the same manner, the power module controller 410 may set a default level of power supplied by a second power module in the boot-up operation of the storage device 50, and flexibly control the power supplied by the second power module.

The power module group 420 may include first and second power modules. The first power module may supply power to the first memory device group. The second power module may supply power to the second memory device group. The number of power modules included in the power module group 420 is not limited to these embodiments.

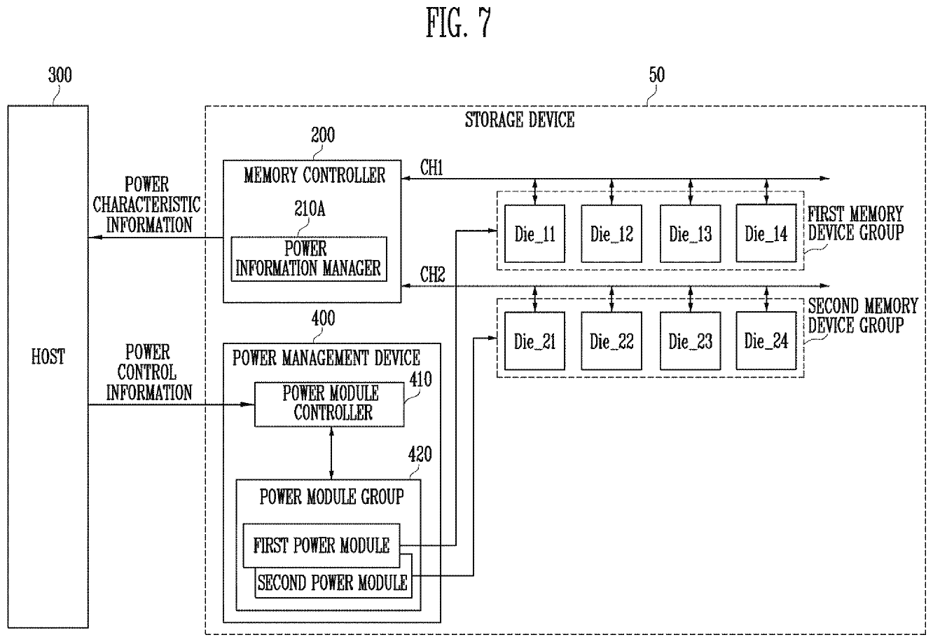

FIG. 8 is a diagram illustrating a configuration and an operation of the memory controller shown in FIG. 7.

Referring to FIG. 8, each of the memory devices 100 may include the skew monitor 131 described with reference to FIG. 2.

In an embodiment, the skew monitor 131 may generate device characteristic information in response to a device characteristic command provided by a power characteristic information generator 211A, and provide the generated device characteristic information to the power characteristic information generator 211A. The device characteristic information may include information on an operation speed characteristic of a memory device 100, which is determined according to a timing skew of the memory device 100.

For example, the skew monitor 131 may measure a timing skew of the memory device 100 by using various methods. The timing skew may be a value representing a degree to which an operation clock of the memory device 100 is delayed with respect to a reference clock. The skew monitor 131 may measure a timing skew of the memory device 100 by using ZQ calibration or Ring Oscillator Delay (ROD).

The skew monitor 131 may determine an operation speed characteristic of the memory device 100, based on a comparison result of the timing skew of the memory device 100 and a reference value. The operation speed characteristic of the memory device 100 may be divided into a fast type, a typical type, and a slow type. The skew monitor 131 may generate device characteristic information representing the determined operation speed characteristic.

In FIG. 8, the power information manager 210A described with reference to FIG. 7 may include the power characteristic information generator 211A and power weight setting table 212A.

For example, the power characteristic information generator 211A may generate power characteristic information corresponding to one memory device group by using device characteristic information respectively corresponding to a plurality of memory devices included in the one memory device group.

The power characteristic information generator 211A may provide a device state command to each of the plurality of memory devices included in the one memory device group, and acquire device characteristic information of each of the plurality of memory devices included in the one memory device group.

The power characteristic information generator 211A may calculate a final power weight code by synthesizing power weight codes of the respective memory devices with reference to the power weight setting table 212A.

The power characteristic information generator 211A may determine a power level to be supplied to the one memory device group according to the final power weight code. The power characteristic information generator 211A may generate power characteristic information representing the power level to be supplied to the one memory device group, which is determined according to the final power weight code. The power characteristic information generator 211A may provide the generated power characteristic information to the host 300.

The power weight setting table 212A may include a power weight code determined according to the operation speed characteristic of the memory device.

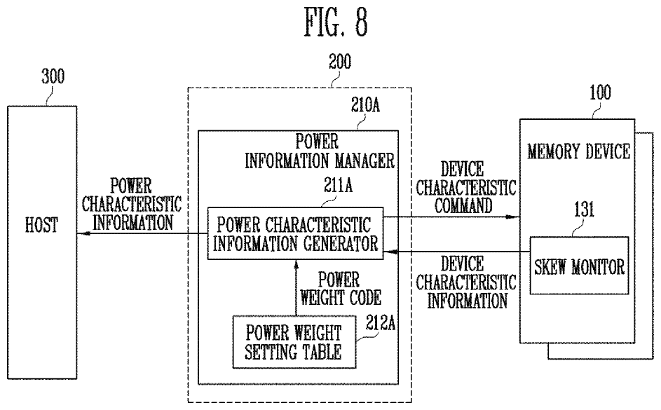

FIG. 9 is a diagram illustrating a configuration and an operation of the storage device in accordance with another embodiment of the present disclosure.

Referring to FIG. 9, the storage device 50 may include first and second memory device groups, a memory controller 200, and a power management device 400.

In FIG. 9, configurations of the first and second memory device groups and the power management device 400 may be described identically to those shown in FIG. 7.

The memory controller 200 may include a power information manager 210B.

The power information manager 210B may generate power characteristic information on each of the first and second memory device groups in the same manner as described with reference to FIG. 7.

In an embodiment, the power information manager 210B may directly provide the generated power characteristic information to the power management device 400 instead of the host 300.

The power information manager 210B may generate power mode information corresponding to the first and second memory device groups.

For example, the power information manager 210B may generate power mode information corresponding to the first memory device group, based on operations that each of memory devices Die_11 to Die_14 included in the first memory device group is performing or is to perform. Each of the memory devices Die_11 to Die_14 may perform or be to perform an operation in response to a request from the host 300 or regardless of the request from the host 300.

The power information manager 210B may generate power mode information corresponding to the second memory device group, based on operations that each of memory devices Die_21 to Die_24 included in the second memory device group is performing or is to perform. Each of the memory devices Die_21 to Die_24 may perform or be to perform an operation in response to a request from the host 300 or regardless of the request from the host 300.

The power information manager 210B may generate power control information. The power information manager 210B may provide the generated power control information to a power module controller 410. The power control information may include power mode information and power characteristic information, which correspond to each of the first and second memory device groups.

The power management device 400 may include the power module controller 410 and a power module group 420. Configurations and operations of the power module controller 410 and the power module group 420 may be described identically to those shown in FIG. 7.

In an embodiment, the power module controller 410 may receive power control information from the power information manager 210B instead of the host 300.

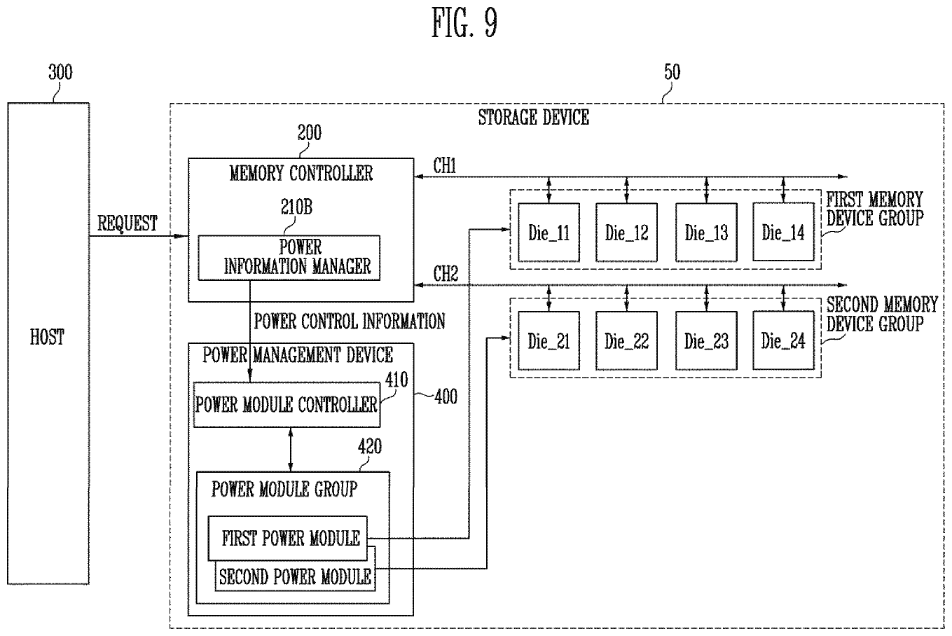

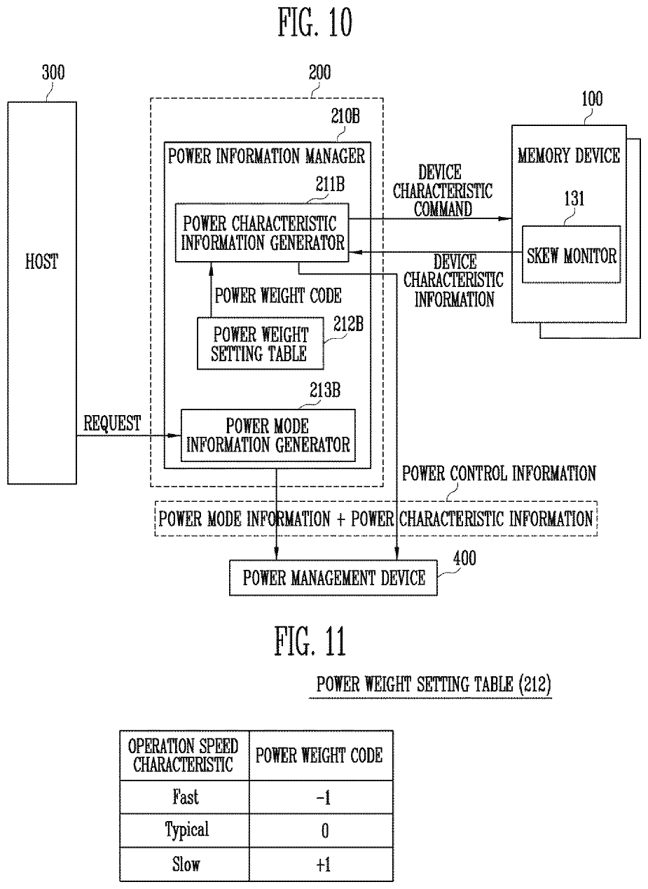

FIG. 10 is a diagram illustrating a configuration and an operation of the memory controller shown in FIG. 9.

Referring to FIG. 10, an operation of a skew monitor 131 included in each of memory devices 100 may be described identically to that shown in FIG. 8.

In FIG. 10, the power information manager 210B described with reference to FIG. 9 may include a power characteristic information generator 211B, a power weight setting table 212B, and a power mode information generator 213B.

The power information manager 210B may generate power control information and provide the generated power control information to the power module controller described with reference to FIG. 9. The power control information may include power characteristic information generated by the power characteristic information generator 211B, which corresponds to one memory device group, and power mode information generated by the power mode information generator 213B.

An operation of the power characteristic information generator 211B and a configuration of the power weight setting table 212B may be described identically to the operation of the power characteristic information generator 211A shown in FIG. 8 and the configuration of the power weight setting table 212A shown in FIG. 8.

Therefore, the power characteristic information generator 211B may generate power characteristic information corresponding to one memory device group in the same manner as the power characteristic information generator 211A shown in FIG. 8.

The power mode information generator 213B may generate power mode information corresponding to one memory device group.

For example, the power mode information generator 213B may generate power mode information, based on operations that each of a plurality of memory devices 100 included in the one memory device group is performing or is scheduled to perform. Each of the plurality of memory devices 100 may perform or be to perform an operation in response to a request from the host 300 or regardless of the request from the host 300.

FIG. 11 is a diagram illustrating the power weight setting tables shown in FIGS. 8 and 10.

Referring to FIG. 11, a power weight setting table 212 has the same configuration as the power weight setting table 212A shown in FIG. 8 and the power weight setting table 212B shown in FIG. 10.

An operation speed characteristic of a memory device may be divided into a fast type, a typical type, and a slow type. In various embodiments, the operation speed characteristic of the memory device may be divided into a larger number of types.

A power weight code may be determined based on the operation speed characteristic of the memory device. For example, power having a higher level may be provided to the memory device as the power weight code has a greater value. Therefore, the power weight code has a lower value as the operation speed characteristic of the memory device becomes faster. On the contrary, the power weight code has a higher value as the operation speed characteristic of the memory device becomes slower. When the operation speed characteristic of the memory device belongs to a reference level, the power weight code may have a predetermined value. In FIG. 11, the predetermined value may be 0. The word “predetermined” as used herein with respect to a parameter, such as a predetermined value, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

For example, when the operation speed characteristic of the memory device is the typical type, the supply of power having the reference level may be required to maintain an operation speed. Therefore, the power weight code may have a value of 0. When the operation speed characteristic of the memory device is the slow type, the supply of power having a level higher than the reference level may be required to increase the operation speed. Therefore, the power weight code may have a positive value. When the operation speed characteristic of the memory device is the fast type, the supply of power having a level lower than the reference level may be required to decrease the operation speed. Therefore, the power weight code may have a negative value.

In other words, when the operation speed characteristic of the memory device is the typical type, the supply of power having the reference level to the memory device may be required to perform a normal operation of the memory device. Therefore, the power weight code may have the value of 0. When the operation speed characteristic of the memory device is the slow type, the supply of power having a level higher than the reference level may be required to perform the normal operation of the memory device. Therefore, the power weight code may have a positive value. When the operation speed characteristic of the memory device is the fast type, the memory device may perform the normal operation even when power having a level lower than the reference level is supplied to the memory device. Therefore, the power weight code may have a negative value.

In FIG. 11, when the operation speed characteristic of the memory device is the typical type, the power weight code may have the value of 0. When the operation speed characteristic of the memory device is the slow type, the power weight code may have a value of +1. When the operation speed characteristic of the memory device is the fast type, the power weight code may have a value of −1.

The magnitude of a value of the power weight code determined based on the operation speed of the memory device is not limited to these embodiments. In various embodiments, when the operation speed characteristic is divided into various types, the magnitude of a value of the power weight code or the difference value between power weight codes may be variously set.

FIG. 12 is a diagram illustrating device characteristic information in accordance with an embodiment of the present disclosure.

Referring to FIG. 12, device characteristic information on each of the memory devices Die_11 to Die_14 included in the first memory device group described with reference to FIG. 7 is illustrated. An operation speed characteristic of the memory device Die_11 is the slow type, and a power weight code of the memory device Die_11 has the value of +1. An operation speed characteristic of the memory device Die_12 is the slow type, and a power weight code of the memory device Die_12 has the value of +1. An operation speed characteristic of the memory device Die_13 is the typical type, and a power weight code of the memory device Die_13 has the value of 0. An operation speed characteristic of the memory device Die_14 is the fast type, and a power weight code of the memory device Die_14 has the value of −1.

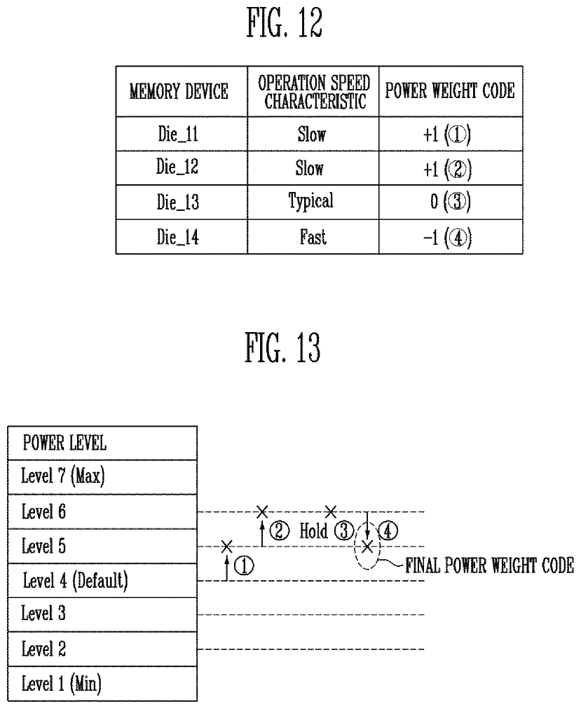

FIG. 13 is a diagram illustrating a power characteristic information generating operation in accordance with an embodiment of the present disclosure.

Referring to FIG. 13, the level of power supplied to a memory device group may be divided into levels from a first level to a seventh level. The number of levels of the power supplied to the memory device group is not limited to these embodiments.

In FIG. 12, the first level may be a minimum level of the supplied power to a corresponding memory device group. The fourth level may be a default level of the supplied power to a corresponding memory device group. The seventh level may be a maximum level of the supplied power to a corresponding memory device group.

Power characteristic information corresponding to the memory device group may be information representing a power level determined based on a final power weight code calculated by synthesizing power weight codes of respective memory devices included in the memory device group.

Referring to FIG. 12, since the operation speed characteristic of the memory device Die_11 is the slow type and the power weight code of the memory device Die_11 has the value of +1, the power level supplied to the memory device group may be increased from the fourth level as the basic level to the fifth level. Since the operation speed characteristic of the memory device Die_12 is the slow type and the power weight code of the memory device Die_12 has the value of +1, the power level supplied to the memory device group may be increased from the fifth level to the sixth level. Since the operation speed characteristic of the memory device Die_13 is the typical type and the power weight code of the memory device Die_13 has the value of 0, the power level supplied to the memory device group may maintain the sixth level. Since the operation speed characteristic of the memory device Die_14 is the fast type and the power weight code of the memory device Die_14 has the value of −1, the power level supplied to the memory device group may be decreased from the sixth level to the fifth level.

Therefore, the power level supplied to the first memory device group, which is determined based on the final power weight code, may be the fifth level. The power level determined according to the power characteristic information may be a power base level set to a static value, when the storage device is booted up.

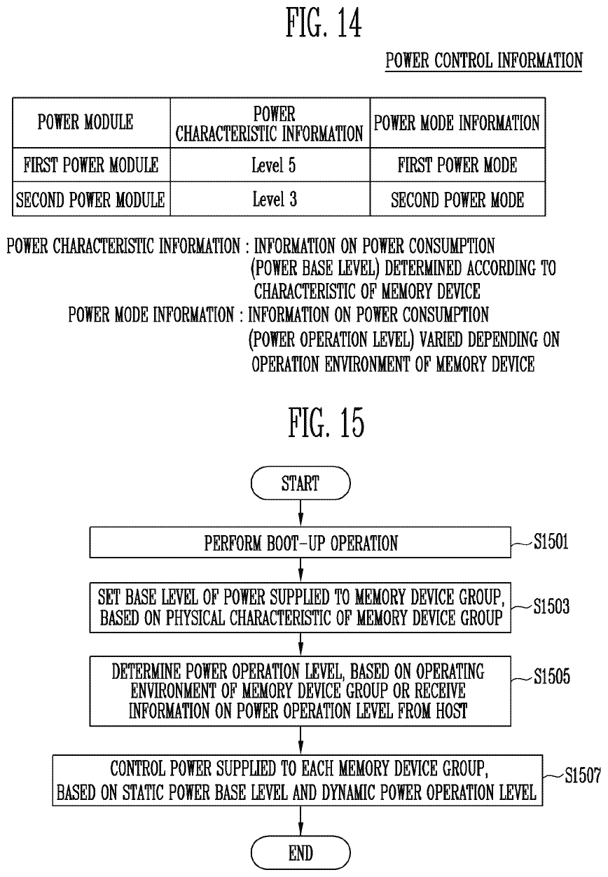

FIG. 14 is a diagram illustrating power control information shown in FIGS. 8 and 10.

Referring to FIG. 14, the power control information may include power characteristic information and power mode information, which are described with reference with FIGS. 8 and 10. The power characteristic information may be information on power consumption (power base level) determined according to a physical device characteristic of a memory device. In an embodiment, the physical device characteristic may indicate an operation speed characteristic of the memory device. The power base level is static, because the power base level is fixed to a value determined in a setup operation, and the value is determined based on the physical device characteristic of the memory device. In an embodiment, a power base level corresponding to a memory device group may be set according to a physical device characteristic of each of memory devices in the memory device group. The power mode information may be information on power consumption (power operation level) varied depending on an operating environment of the memory device. The power operation level is dynamic according to what operation the memory device performs. In an embodiment, a power operation level corresponding to a memory device group may be set according to an operating environment of each of memory devices in the memory device group.

The operating environment of the memory device may indicate which operating state the memory device is in with regard to power consumption. In an embodiment, the operation state may include a standby state for power saving, a state of performing a foreground operation according to a request of the host, a state of performing a background operation irrelevant to the request of the host, and so on.

In an embodiment, the operation state may be subdivided according to the type of operation performed by the memory device. For example, an operation state when performing an erase operation or a program operation with high power consumption and an operation state when performing a read operation with relatively low power consumption may be different.

In FIG. 14, the power level of a first power module may be a fifth level, and the power mode of the first power module may be a first power mode. The power level of a second power module may be a third level, and the power mode of the second power module may be a second power mode.

Therefore, a base level of power that the first power module supplies to a first memory device may be set higher than that of power that the second power module supplies to a second memory device group. The base level of the power may be set in a boot-up operation of the storage device.

The power that the first power module provides to the first memory device group may be flexibly controlled according to the first power mode. The power that the second power module provides the second memory device group may be flexibly controlled according to the second power mode.

Therefore, when the first power mode and the second power mode are the same power mode, the first power module may supply power having a level higher than that of power supplied by the second power module. That is, a power level may determine a base level of power supplied by a power module when the same power mode is provided, and a setup operation of setting the base level of the power may be performed whenever the boot-up operation of the storage device is performed.

A power mode may be changed depending on a change in operation state of memory devices included in a memory device group, such as a low power mode, a default mode, or a high power mode. A power operation level in the high power mode may be higher than that in the low power mode. Therefore, in a state in which power levels of power modules are set to the same power level, power base levels of the power modules are the same, but a larger amount of power may be supplied since the power operation level in the high power mode is higher than that in the low power mode.

Therefore, when the first power mode is a power mode different from the second power mode, it is not ensured that the first power module supplies power having a level higher than that of the second power module. According to each power mode, power supplied by the second power module may be higher than that supplied by the first power module. For example, when the first power mode is the low power mode and the second power mode is the high power mode, the second power module may supply a large amount of power as compared with the first power module depending on a situation.

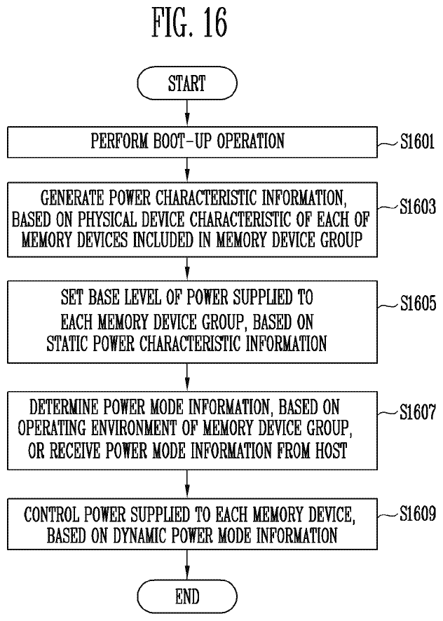

FIG. 15 is a flowchart illustrating an operation of the storage device in accordance with an embodiment of the present disclosure.

Referring to FIG. 15, in step S1501, the storage device may perform a boot-up operation.

In step S1503, the storage device may set a base level of power supplied to a memory device group, based on a physical device characteristic of each of memory device included in the memory device group.

In step S1505, the storage device may determine a power operation level, based on an operating environment of the memory device group, or receive information on the power operation level from the host. The power operation level may be a level of power consumed by the memory device group, which is flexibly changed depending on the operating environment of the memory device group.

In step S1507, the storage device may control power supplied to each memory device group, based on a static power base level determined in a setup operation and a dynamic power operation level flexibly changed depending on the operating environment of the memory device group.

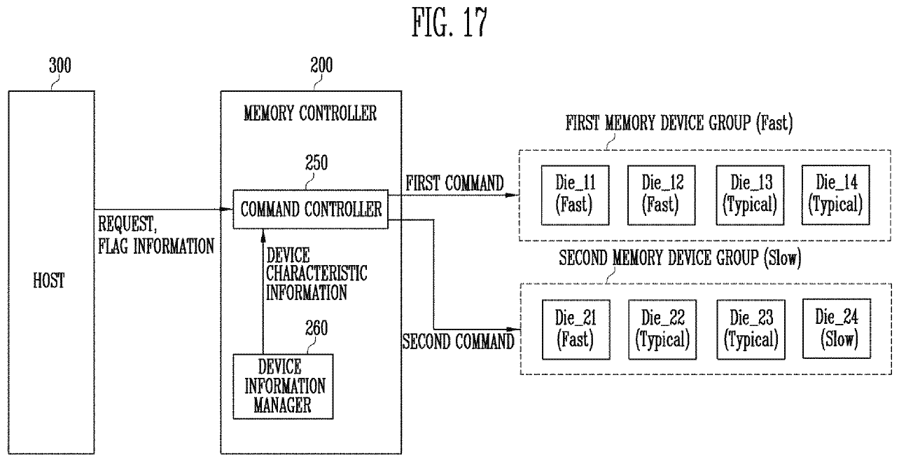

FIG. 16 is a flowchart illustrating an operation of the storage device in accordance with an embodiment of the present disclosure.

Referring to FIG. 16, in step S1601, the storage device may perform a boot-up operation,

In step S1603, the storage device may generate power characteristic information, based on a physical device characteristic of each of memory devices included in a memory device group.

In step S1605, the storage device may set a base level of power supplied to each memory device group, based on static power characteristic information. The base level of the power may be fixed to a value determined in the boot-up operation of the storage device.

In step S1607, the storage device may generate power mode information, based on an operating environment of the memory device group, or receive the power mode information from the host.

In step S1609, the storage device may control power supplied to each memory device, based on dynamic power mode information. In other words, the storage device may flexibly control power supplied based on a power operation level determined according to an operation state of the memory device.

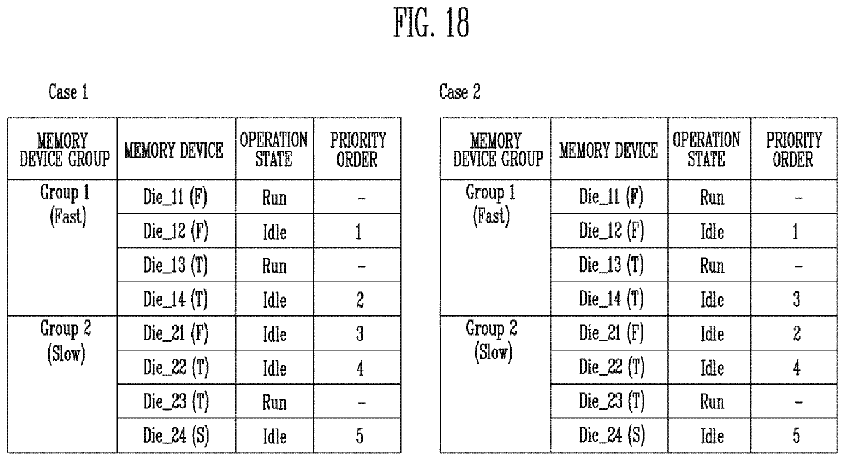

FIG. 17 is a diagram illustrating a configuration and an operation of the storage device in accordance with another embodiment of the present disclosure.

Referring to FIG. 17, a first memory device group may include memory devices Die_11 to Die_14. A second memory group may include memory devices Die_21 to Die_24.

In FIG. 17, the operation speed characteristic of each of the memory devices Die_11, Die_12, and Die_21 may be the fast type. The operation speed characteristic of each of the memory devices Die_13, Die_14, Die_22, and Die_23 may be the typical type. The operation speed characteristic of the memory device Die_24 may be the slow type.

When the final power weight code described with reference to FIGS. 12 and 13 is considered, the operation speed characteristic of the first memory device group may be relatively the fast type as compared with that of the second memory device group. On the contrary, the operation speed characteristic of the second memory device group may be relatively the slow type as compared with that of the first memory device group.

The memory devices Die_11 to Die_14 included in the first memory device group may be commonly coupled to the memory controller 200 through one channel. The memory devices Die_21 to Die_24 included in the second memory device group may be commonly coupled to the memory controller 200 through one channel.

In an embodiment, the memory controller 200 may include a command controller 250 and a device information manager 260.

The command controller 250 may provide a command to each memory device included in a memory device group. The command controller 250 may set priority orders of the memory device group and the memory devices, based on device characteristic information received from the device information manager 260. The priority order of a memory device may be set higher as the operation speed characteristic of the memory device becomes faster. The priority order of a memory device may be set lower as the operation speed characteristic of the memory device becomes slower.

The command controller 250 may simultaneously receive a request and flag information from the host 300. The flag information may be information representing whether the request provided by the host 300 is a priority request.

For example, when the flag information has a logic value ‘1,’ the request may be a priority request. When the flag information has a logic value ‘0,’ the request may be a general request. In another embodiment, when the flag information has the logic value ‘0,’ the request may be a priority request. When the flag information has a logic value ‘1,’ the request may be a general request. In various embodiments, the flag information may include information representing a priority order that the request has. The flag information may include data of two or more bits according to the number of priority orders.

The command controller 250 may determine whether the request provided by the host 300 is a priority request. The priority request may be a request expected that an operation speed characteristic will be processed in a fast memory device.

The command controller 250 may receive device characteristic information from the device information manager 260. The device characteristic information may include information on an operation speed characteristic of each memory device included in a memory device group. The command controller 250 may set priority orders of the memory device group and each memory device, based on information on the operation speed characteristic of the memory device. The command controller 250 may set a priority order with respect to a memory device in a standby state. The command controller 250 may set the priority order of the memory device to be higher as the operation speed of the memory device becomes faster. The command controller 250 may set the priority order of the memory device to be lower as the operation speed of the memory device becomes slower.

The command controller 250 may provide the memory device with a command and data in response to a request from the host 300 by considering priority orders of the memory device group and the memory device.

For example, when the request from the host 300 is a priority request, the command controller 250 may provide the memory device with the command and the data in response to the request from the host 300 by considering the priority order of the memory device. When the request from the host 300 is a general request, the command controller 250 may provide the memory device with the command and the data in response to the request from the host 300, regardless of the priority order of the memory device.

For example, a first command may be a command according to the priority request from the host 300. The first command is expected to be processed in the memory device having a fast operation speed characteristic, and therefore, the command controller 250 may provide the first command to the first memory device group.

The command controller 250 may provide the first command and data according to the first command to any one memory device among the memory devices belonging to the first memory device group by considering priority orders. In an embodiment, the command controller 250 may provide the first command and the data according to the first command to a memory device having a highest priority order among the memory devices belonging to the first memory device group.

A second command may be a command according to the general request from the host 300. The second command is not expected to be processed in a memory device having a fast operation speed characteristic, and therefore, the command controller 250 may provide the second command and data according to the second command to any one memory device among the memory devices belonging to the second memory device group, regardless of priority orders. Alternatively, the command controller 250 may provide the second command and the data according to the second command to any one memory device among the memory devices belonging to the second memory device group, according to the existing command management policy. For example, the command controller 250 may provide the second command and the data according to the second command to a memory device in sequence in which the priority order is lower than a reference order.

The device information manager 260 may correspond to the power information manager described with reference to FIG. 10. In other words, the device information manager 260 may provide a device characteristic command to each memory device, and acquire device characteristic information from each memory device. The device characteristic information may include information on an operation speed characteristic of the memory device.

FIG. 18 is a diagram illustrating an operation of determining priority orders of the memory devices shown in FIG. 17.

Referring to FIG. 18, a priority order of a memory device may be determined according to a memory device group to which the memory device belongs, an operation speed characteristic of the memory device, and an operation state of the memory device.

For example, when the operation state is already running (Run), the memory device cannot perform an operation according to a new command. Therefore, the memory device is excluded from targets to be prioritized. In other words, memory devices of which operation states are idle (Idle) may be included in the targets to be prioritized.

A priority order of a memory device group may be determined by considering an operation speed characteristic of each of memory devices included in the memory device group. For example, when different operation weight codes are provided depending on an operation speed characteristic, the operation weight code may have a value of +1 when the operation speed characteristic is the fast type. When the operation speed characteristic is the typical type, the operation weight code may have a value of 0. When the operation speed characteristic is the slow type, the operation weight code may have a value of −1.

When a calculation is performed using a method similar to the power weight code calculation described with reference to FIG. 13, the final operation weight code of the first memory device group Group 1 may have a value of 2. The final operation weight code of the second memory device group Group 2 may have a value of 0. Therefore, the first memory device group Group 1 has a priority order higher than that of the second memory device group Group 2. The first memory device group Group 1 may have an operation speed faster than that of the second memory device group Group 2.

A first case Case 1 is an example in which a priority order of each memory device is set by giving weight to the operation speed of the memory device group as compared with the operation speed of the memory device.

Since the operation speed of the first memory device group Group 1 is faster than that of the second memory device group Group 2, priority orders may be preferentially provided to the memory devices Die_11 to Die_14 in the first memory device group Group 1. Since the memory devices Die_11 to Die_13 are operating, the memory devices Die_11 and Die_13 are excluded from targets to be prioritized. Since the memory devices Die_12 and Die_14 are standing by, the memory devices Die_12 and Die_14 may be included in the targets to be prioritized. Since the memory device Die_12 is faster than the memory device Die_14, the priority order of the memory device Die_12 may be selected as a first order. The priority order of the memory device Die_14 may be selected as a second order.

In the same manner, priority orders may be provided to the memory devices Die_21 to Die_24 in the second memory device group Group 2. Since the memory device Die_23 is operating, the memory device Die_23 is excluded from targets to be prioritized. The priority order of the memory device Die_21 may be selected as a third order. The priority order of the memory device Die_22 may be selected as a fourth order. The priority order of the memory device Die_24 may be selected as a fifth order.

A second case Case 2 is an example in which a priority order of each memory device is set by giving weight to the operation speed of the memory device as compared with the operation speed of the memory device group.

Since the memory devices Die_11, Die_13, and Die_24 are operating, the memory devices Die_11, Die_13, and Die_24 are excluded from targets to be prioritized. The priority order of the memory device Die_12 belonging to the first memory device group Group 1, which has a high priority order between the memory devices Die_12 and Die_21 of which the operation speed characteristics are the fast type, may be set as a first order. The priority order of the memory device Die_21 may be set as a second order.

The priority order of the memory device Die_14 belonging to the first memory group Group 1, which has a high priority order between the memory devices Die_14 and Die_22 of which the operation speed characteristic are the typical type, may be set as a third order. The priority order of the memory device Die_22 may be set as a fourth order.

The priority order of the memory device Die_24 of which the operation speed characteristic is the slow type may be set as a fifth order.

The priority order of each memory device may be variously set depending on an operation characteristic of the memory device. In various embodiments, the priority orders of memory devices, which are equal to or smaller than the reference order, may be set as the same order. On the contrary, the priority orders of memory devices, which are equal to or greater than the reference order, may be set as the same order.

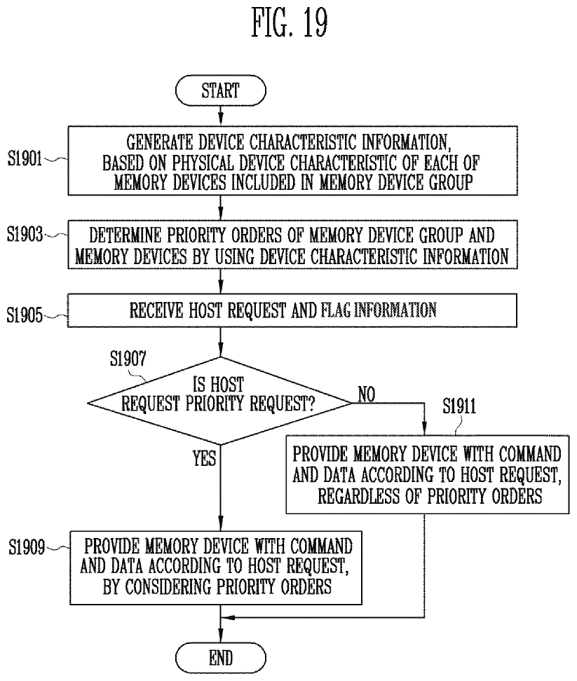

FIG. 19 is a flowchart illustrating an operation of the memory controller shown in FIG. 17.

Referring to FIG. 19, in step S1901, the memory controller may generate device characteristic information, based on a physical device characteristic of each of memory devices included in a memory device group. The device characteristic information may include information on an operation speed characteristic of each memory device.

In step S1903, the memory controller may determine priority orders of the memory device group and the memory devices by using the device characteristic information.

In step S1905, the memory controller may receive a host request and flag information.

In step S1907, the memory controller may determine whether the host request is a priority request, based on the flag information. As the determination result, when the host request is the priority request, the memory controller proceeds to step S1909. As the determination result, when the host request is a general request instead of the priority request, the memory controller proceeds to step S1911.

In the step S1909, the memory controller may provide a memory device with a command and data according to the host request, by considering the priority orders of the memory devices. For example, the memory controller may provide a command and data to a memory device having the highest priority order among memory devices in the standby state.

In the step S1911, the memory controller may provide a memory device with a command and data according to the host request, regardless of the priority orders of the memory devices. Alternatively, the memory controller may provide a memory device with a command and data according to the host request, based on the existing memory command scheduling policy.[

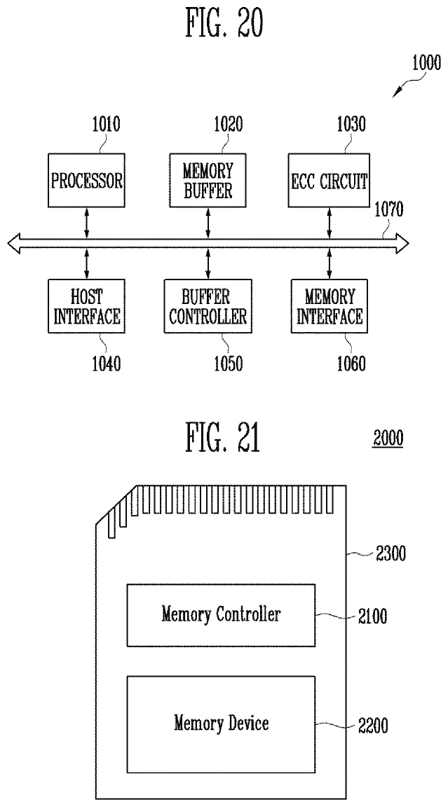

FIG. 20 is a diagram illustrating another embodiment of the memory controller shown in FIG. 1.

Referring to FIG. 20, a memory controller 1000 is coupled to a host and a memory device. The memory controller 1000 is configured to access the memory device in response to a request received from the host. For example, the memory controller 1000 is configured to control read, program, erase, and background operations of the memory device. The memory controller 1000 is configured to provide an interface between the memory device and the host. The memory controller 1000 is configured to drive firmware for controlling the memory device.

The memory controller 1000 may include a processor 1010, a memory buffer 1020, an error correction code (ECC) circuit 1030, a host interface 1040, a buffer controller 1050, a memory interface 1060, and a bus 1070.

The bus 1070 may be configured to provide channels between components of the memory controller 1000.

The processor 1010 may control overall operations of the memory controller 1000, and perform a logical operation. The processor 1010 may communicate with the external host through the host interface 1040, and communicate with the memory device through the memory interface 1060. Also, the processor 1010 may communicate with the memory buffer 1020 through the buffer controller 1050. The processor 1010 may control an operation of the storage device, using the memory buffer 1020 as a working memory, a cache memory or a buffer memory.

The processor 1010 may perform a function of a flash translation layer (FTL). The processor 1010 may translate a logical block address (LBA) provided by the host through the FTL into a physical block address (PBA). The FTL may receive an LPA, using a mapping table, to be translated into a PBA. Several address mapping methods of the FTL exist according to mapping units. A representative address mapping method includes a page mapping method, a block mapping method, and a hybrid mapping method.

The processor 1010 is configured to randomize data received from the host. For example, the processor 1010 may randomize data received from the host, using a randomizing seed. The randomized data is provided as data to be stored to the memory device to be programmed in the memory cell array.

In a read operation, the processor 1010 is configured to derandomize data received from the memory device. For example, the processor 1010 may derandomize data received from the memory device, using a derandomizing seed. The derandomized data may be output to the host.

In an embodiment, the processor 1010 may perform randomizing and derandomizing by driving software or firmware.

The memory buffer 1020 may be used as the working memory, the cache memory, or the buffer memory of the processor 1010. The memory buffer 1020 may store codes and commands, which are executed by the processor 1010. The memory buffer 1020 may include a Static RAM (SRAM) or a Dynamic RAM (DRAM).

The ECC circuit 1030 may perform an ECC operation. The ECC circuit 1030 may perform ECC encoding on data to be written in the memory device through the memory interface 1060. The ECC encoded data may be transferred to the memory device through the memory interface 1060. The ECC circuit 1030 may perform ECC decoding on data received from the memory device through the memory interface 1060. In an example, the ECC circuit 1030 may be included as a component of the memory interface 1060 in the memory interface 1060.

The host interface 1040 may communicate with the external host under the control of the processor 1010. The host interface 1040 may communicate with the host, using at least one of various communication manners, such as a Universal Serial bus (USB), a Serial AT Attachment (SATA), a High Speed InterChip (HSIC), a Small Computer System Interface (SCSI), Firewire, a Peripheral Component Interconnection (PCI), a PCI express (PCIe), a NonVolatile Memory Express (NVMe), a Universal Flash Storage (UFS), a Secure Digital (SD), a Multi-Media Card (MMC), an embedded MMC (eMMC), a Dual In-line Memory Module (DIMM), a Registered DIMM (RDIMM), and a Load Reduced DIMM (LRDIMM).

The buffer controller 1050 is configured to control the memory buffer 1020 under the control of the processor 1010.

The memory interface 1060 is configured to communicate with the memory device under the control of the processor 1010. The memory interface 1060 may communicate a command, an address, and data with the memory device through a channel.

In an example, the memory controller 1000 might not include the memory buffer 1020 and the buffer controller 1050.

In an example, the processor 1010 may control an operation of the memory controller 1000 by using codes. The processor 1010 may load codes from a nonvolatile memory device (e.g., a read only memory (ROM)) provided in the memory controller 1000. In another example, the processor 1010 may load codes from the memory device through the memory interface 1060.

In an example, the bus 1070 of the memory controller 1000 may be divided into a control bus and a data bus. The data bus may be configured to transmit data in the memory controller 1000, and the control bus may be configured to transmit control information such as a command and an address in the memory controller 1000. The data bus and the control bus are separated from each other, and might not interfere or influence with each other. The data bus may be coupled to the host interface 1040, the buffer controller 1050, the ECC circuit 1030, and the memory interface 1060. The control bus may be coupled to the host interface 1040, the processor 1010, the buffer controller 1050, the memory buffer 1020, and the memory interface 1060.

FIG. 21 is a block diagram illustrating a memory card system to which the storage device is applied in accordance with an embodiment of the present disclosure.

Referring to FIG. 21, the memory card system 2000 includes a memory controller 2100, a memory device, and a connector 2300.

The memory controller 2100 is coupled to the memory device 2200. The memory controller 2100 is configured to access the memory device 2200. For example, the memory controller 2100 is configured to control read, write, erase, and background operations of the memory device 2200. The memory controller 2100 is configured to provide an interface between the memory device 2200 and a host. The memory controller 2100 is configured to driver firmware for controlling the memory device 2200. The memory controller 2100 may be implemented identically to the memory controller 200 described with reference to FIG. 1.

In an example, the memory controller 2100 may include components such as a Random Access Memory (RAM), a processing unit, a host interface, a memory interface, and an ECC circuit.

The memory controller 2100 may communicate with an external device through the connector 2300. The memory controller 2100 may communicate with the external device (e.g., the host) according to a specific communication protocol. In an example, the memory controller 2100 may communicate with the external device through at least one of various communication protocols such as a Universal Serial Bus (USB), a Multi-Media Card (MMC), an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), firewire, a Universal Flash Storage (UFS), Wi-Fi, Bluetooth, and NVMe.

In an example, the memory device 2200 may be implemented with various nonvolatile memory devices such as an Electrically Erasable and Programmable ROM (EEPROM), a NAND flash memory, a NOR flash memory, a Phase-change RAM (PRAM), a Resistive RAM (ReRAM), a Ferroelectric RAM (FRAM), and a Spin Torque Transfer magnetic RAM (STT-MRAM).

The memory controller 2100 and the memory device 2200 may be integrated into a single semiconductor device, to constitute a memory card. For example, the memory controller 2100 and the memory device 2200 may constitute a memory card such as a PC card (Personal Computer Memory Card International Association (PCMCIA)), a Compact Flash (CF) card, a Smart Media Card (SM and SMC), a memory stick, a Multi-Media Card (MMC, RS-MMC, MMCmicro and eMMC), an SD card (SD, miniSD, microSD and SDHC), and a Universal Flash Storage (UFS).

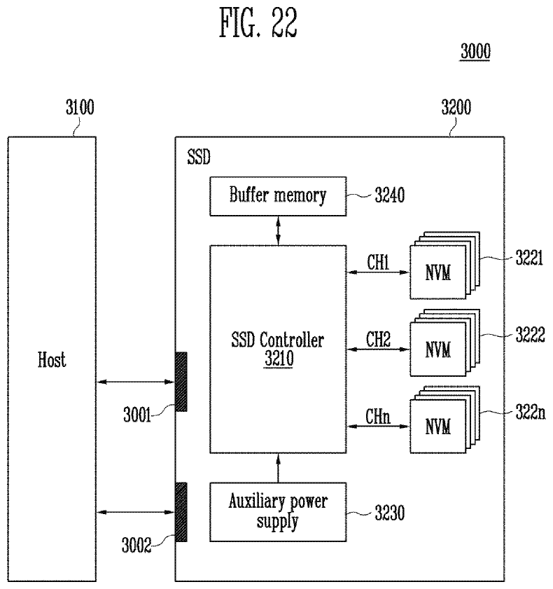

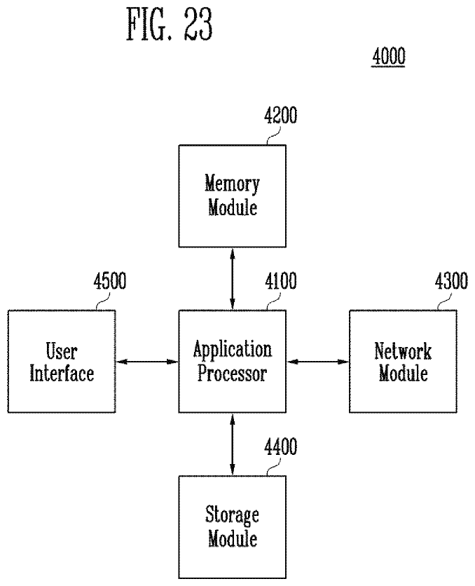

FIG. 22 is a block diagram illustrating, for example, a Solid State Drive (SSD) system to which the storage device is applied in accordance with an embodiment of the present disclosure.

Referring to FIG. 22, the SSD system 3000 includes a host 3100 and an SSD 3200. The SSD 3200 exchanges a signal SIG with the host 3100 through a signal connector 3001, and receives power PWR through a power connector 3002. The SSD 3200 includes an SSD controller 3210, a plurality of flash memories 3221 to 322n, an auxiliary power supply 3230, and a buffer memory 3240.

In an embodiment, the SSD controller 3210 may serve as the memory controller 200 described with reference to FIG. 1.

The SSD controller 3210 may control the plurality of flash memories 3221 to 322n in response to a signal SIG received from the host 3100. In an example, the signal SIG may be a signal based on an interface between the host 3100 and the SSD 3200. For example, the signal SIG may be a signal defined by at least one of interfaces such as a Universal Serial Bus (USB), a Multi-Media Card (MMC), an embedded MMC (eMMC), a Peripheral Component Interconnection (PCI), a PCI express (PCIe), an Advanced Technology Attachment (ATA), a Serial-ATA (SATA), a Parallel-ATA (PATA), a Small Computer System Interface (SCSI), an Enhanced Small Disk Interface (ESDI), an Integrated Drive Electronics (IDE), a firewire, a Universal Flash Storage (UFS), a WI-FI, a Bluetooth, and an NVMe.

The auxiliary power supply 3230 is coupled to the host 3100 through the power connector 3002. When the supply of power from the host 3100 is not smooth, the auxiliary power supply 3230 may provide power of the SSD 3200. In an example, the auxiliary power supply 3230 may be located in the SSD 3200, or be located at the outside of the SSD 3200. For example, the auxiliary power supply 3230 may be located on a main board, and provide auxiliary power to the SSD 3200.

The buffer memory 3240 operates as a buffer memory of the SSD 3200. For example, the buffer memory 3240 may temporarily store data received from the host 3100 or data received from the plurality of flash memories 3221 to 322n, or temporarily store meta data (e.g., a mapping table) of the flash memories 3221 to 322n. The buffer memory 3240 may include volatile memories such as a DRAM, an SDRAM, a DDR SDRAM, an LPDDR SDRAM, and a GRAM or nonvolatile memories such as a FRAM, a ReRAM, an STT-MRAM, and a PRAM.

FIG. 23 is a block diagram illustrating a user system to which the storage device is applied in accordance with an embodiment of the present disclosure.

Referring to FIG. 23, the user system 4000 includes an application processor 4100, a memory module 4200, a network module 4300, a storage module 4400, and a user interface 4500.

The application processor 4100 may drive components included in the user system 4000, an operating system (OS), a user program, or the like. In an example, the application processor 4100 may include controllers for controlling components included in the user system 4000, interfaces, a graphic engine, and the like. The application processor 4100 may be provided as a System-on-Chip (SoC).

The memory module 4200 may operate as a main memory, working memory, buffer memory or cache memory of the user system 4000. The memory module 4200 may include volatile random access memories such as a DRAM, an SDRAM, a DDR SDRAM, a DDR2 SDRM, a DDR3 SDRAM, an LPDDR SDRAM, an LPDDR2 SDRAM, and an LPDDR3 SDRAM or nonvolatile random access memories such as a PRAM, a ReRAM, an MRAM, and a FRAM. In an example, the application processor 4100 and the memory module 4200 may be provided as one semiconductor package by being packaged based on a Package on Package (PoP).

The network module 4300 may communicate with external devices. In an example, the network module 4300 may support wireless communications such as Code Division Multiple Access (CDMA), Global System for Mobile communication (GSM), Wideband CDMA (WCDMA), CDMA-2000, Time Division Multiple Access (TDMA), Long Term Evolution (LTE), Wimax, WLAN, UWB, Bluetooth, and Wi-Fi. In an example, the network module 4300 may be included in the application processor 4100.

The storage module 4400 may store data. For example, the storage module 4400 may store data received from the application processor 4100. Alternatively, the storage module 4400 may transmit data stored therein to the application processor 4100. In an example, the storage module 4400 may be implemented with a nonvolatile semiconductor memory device such as a Phase-change RAM (PRAM), a Magnetic RAM (MRAM), a Resistive RAM (RRAM), a NAND flash, a NOR flash, or a NAND flash having a three-dimensional structure. In an example, the storage module 4400 may be provided as a removable drive such as a memory card of the user system 4000 or an external drive.

In an example, the storage module 4400 may include a plurality of nonvolatile memory devices, and the plurality of nonvolatile memory devices may operate identically or substantially the same to the memory device 100 described with reference to FIG. 1. The storage module 4400 may operate identically or substantially the same to the storage device 50 described with reference to FIG. 1.

The user interface 4500 may include interfaces for inputting data or commands to the application processor 4100 or outputting data to an external device. In an example, the user interface 4500 may include user input interfaces such as a keyboard, a keypad, a button, a touch panel, a touch screen, a touch pad, a touch ball, a camera, a microphone, a gyroscope sensor, a vibration sensor and a piezoelectric element. The user interface 4500 may include user output interfaces such as a Liquid Crystal Display (LCD), an Organic Light Emitting Diode (OLED) display device, an Active Matrix OLED (AMOLED) display device, an LED, a speaker, and a monitor.

In accordance with the present disclosure, there can be provided a storage device having efficient power supply capability and an operating method thereof.

While the present disclosure has been shown and described with reference to certain examples of embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described examples of embodiments but should be determined by not only the appended claims but also the equivalents thereof.

In the above-described embodiments, all steps may be selectively performed or part of the steps and may be omitted. In each embodiment, the steps are not necessarily performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the examples of embodiments of the present disclosure have been described in the drawings and specification. Although specific terminologies are used here, those are only to explain the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein.

What is claimed is:

1. A storage device comprising:
a memory device group comprising a plurality of memory devices;
a memory controller configured to generate power characteristic information on power consumed by the memory device group, based on a physical device characteristic of each of the plurality of memory devices; and
a power management device configured to control power supplied to the memory device group, based on the power characteristic information and power mode information,
wherein the power mode information refers to power consumption determined according to an operating environment of the memory device group.

2. The storage device of claim 1,
wherein the plurality of memory devices included in the memory device group are coupled to the memory controller through at least one channel,
wherein the memory controller provides the power characteristic information to a host, and
wherein the power management device receives the power characteristic information and the power mode information from the host.

3. The storage device of claim 1, wherein the memory controller generates the power characteristic information, after the storage device has boot up.

4. The storage device of claim 1, wherein the memory controller provides a device characteristic command to a memory device, and acquires device characteristic information on an operation speed of the memory device from the memory device.

5. The storage device of claim 4, wherein the memory device comprises a skew monitor configured to generate the device characteristic information by comparing a timing skew of the memory device with a reference value.

6. The storage device of claim 5, wherein the skew monitor measures the timing skew, based on Ring Oscillator Delay (ROD) or ZQ calibration of the memory device.

7. The storage device of claim 4, wherein the memory controller generates the power characteristic information by using power weight codes corresponding to each of the plurality of memory devices,
wherein the device characteristic information comprises a power weight code determined according to the operation speed of the memory device.

8. The storage device of claim 1, wherein the power management device comprises:
a power module configured to supply power to the memory device group; and
a power module controller configured to control power supplied by the power module, based on the power characteristic information and the power mode information.

9. The storage device of claim 8, wherein the power module controller sets a base level of the supplied power based on the power characteristic information, and controls the supplied power based on the power mode information determined based on operations that each of the plurality of memory devices is performing or is scheduled to perform.

10. A storage device comprising:
a memory device group comprising a plurality of memory devices;
a memory controller configured to generate power characteristic information on power consumed by the memory device group, based on a physical device characteristic of each of the plurality of memory devices, and generate power mode information on power consumed by the memory device group, based on an operating environment of the memory device group; and
a power management device configured to control power supplied to the memory device group, based on the power characteristic information and the power mode information.

11. The storage device of claim 10, wherein the plurality of memory devices included in the memory device group are coupled to the memory controller through at least one channel.

12. The storage device of claim 10, wherein the memory controller generates the power mode information based on operations that each of the plurality of memory devices is performing or is scheduled to perform.

13. The storage device of claim 10, wherein the memory controller generates the power characteristic information, after the storage device has boot up.

14. The storage device of claim 10, wherein the memory controller provides a device characteristic command to a memory device, and acquires device characteristic information on an operation speed of the memory device from the memory device.

15. The storage device of claim 14, wherein the memory device comprises a skew monitor configured to measure a timing skew of the memory device, and generate the device characteristic information by comparing the timing skew with a reference value.

16. The storage device of claim 14, wherein the memory controller generates the power characteristic information by using power weight codes corresponding to each of the plurality of memory devices,
wherein the device characteristic information comprises a power weight code determined according to the operation speed of the memory device.

17. The storage device of claim 10, wherein the power management device comprises:
a power module configured to supply power to the memory device group; and
a power module controller configured to set a base level of power supplied by the power module, based on the power characteristic information, and control the supplied power, based on the power mode information determined based on operations that each of the plurality of memory devices is performing or is scheduled to perform.

18. A method for operating a storage device, the method comprising:
generating power characteristic information on power consumed by a memory device group comprising a plurality of memory devices, based on a physical device characteristic of each of the plurality of memory devices;
setting a base level of power supplied to the memory device group, based on the power characteristic information; and
controlling the supplied power, based on power mode information on power consumption, which is determined based on an operating environment of the memory device group.

19. The method of claim 18, wherein the generating of the power characteristic information comprises:
generating device characteristic information indicating an operation speed of each of the plurality of memory devices; and
generating the power characteristic information by using power weight codes in the device characteristic information,
wherein the device characteristic information comprises a power weight code determined according to the operation speed of the memory device.

20. The method of claim 19, wherein the generating of the device characteristic information comprises:
measuring a timing skew of a memory device; and
generating the device characteristic information corresponding to the memory device, based on a comparison result of the timing skew and a reference value.

21. The method of claim 18, further comprising receiving the power mode information from a host.

22. The method of claim 18, further comprising generating the power mode information, based on operations that each of the plurality of memory device is performing or is scheduled to perform.
